(19) United States
(12) Patent Application Publication
(10) Pub. No.: US 2017/0178199 A1
(43) Pub. Date: Jun. 22, 2017

(54) METHOD AND SYSTEM FOR ADAPTIVELY PROVIDING PERSONALIZED MARKETING EXPERIENCES TO POTENTIAL CUSTOMERS AND USERS OF A TAX RETURN PREPARATION SYSTEM

(71) Applicant: Intuit Inc., Mountain View, CA (US)

(72) Inventors: Joseph Cessna, San Diego, CA (US); Massimo Mascaro, San Diego, CA (US); Peter Ouyang, San Diego, CA (US)

(73) Assignee: Intuit Inc., Mountain View, CA (US)

(21) Appl. No.: 14/979,094

(22) Filed: Dec. 22, 2015

(51) Int. Cl. G06Q 30/02; H04L 29/08; G06Q 40/00

(52) U.S. Cl. CPC G06Q 30/0271; G06Q 30/0201; G06Q 40/123; H04L 67/02; G06Q 30/0277

(57) ABSTRACT

A method and system adaptively improves potential customer conversion rates, revenue metrics, and/or other target metrics by providing effective marketing experience options, from a variety of different marketing experience options, to some users while concurrently testing user responses to other marketing experience options, according to one embodiment. The method and system selects the marketing experience options by applying user characteristics data to an analytics model, according to one embodiment. The method and system analyzes user responses to the marketing experience options to update the analytics model, and to dynamically adapt the personalization of the marketing experience options, at least partially based on feedback from users, according to one embodiment.

### BACKGROUND

Federal and State Tax law has become so complex that it is now estimated that each year Americans alone use over 6 billion person hours, and spend nearly 4 billion dollars, in an effort to comply with Federal and State Tax statutes. Given this level of complexity and cost, it is not surprising that more and more taxpayers find it necessary to obtain help, in one form or another, to prepare their taxes. Tax return preparation systems, such as tax return preparation software programs and applications, represent a potentially flexible, highly accessible, and affordable source of tax preparation assistance. However, despite the many benefits tax return preparation systems offer, some users need to be reminded, persuaded, and/or incentivized to use or commit to using particular tax return preparation systems.

Marketing initiatives can be used to attract users to tax return preparation systems, in order to convert potential customers to paying customers, and/or to retain or recommit previous customers. Unfortunately, traditional marketing initiatives, such as email campaigns and other forms of advertisements are impersonal and rely on pre-defined or static criteria for distributing marketing content.

Traditional marketing initiatives that rely on pre-defined or static criteria for distributing marketing content can be extraordinarily ineffective. For example, a particular marketing email might be sent out to all Californians or to all Texans, while the content of the email may only be effective/persuasive to male Californians or female Texans. The lack of customization and/or personalization for a particular audience may not only be ineffective, but may also be a waste of resources (e.g., money, computing resources, employee time).

Traditional marketing initiatives are reasonable to rely on pre-defined or static criteria for distributing marketing content because providing customized marketing initiatives using traditional techniques can be difficult, costly, and inaccurate. For example, one traditional technique for determining user preferences includes hiring a consultant company to perform telephonic surveys to pockets/samples of people. Because a telephone conversation is time consuming and because certain people do not speak to solicitors, the sample of opinions is necessarily biased—not representative of all people. Therefore, in additional to being slow and expensive, traditional techniques for determining potential customer preferences is inaccurate. What's more, even after purportedly “useful” or “preferred” content is selected, mechanisms for selecting a delivery audience and mechanisms for physically delivering content can be another resource-intensive task, which may or may not provide sufficient return on investment to make good business sense.

What is needed is a method and system for adaptively providing personalized marketing experiences to potential customers and users of a tax return preparation system, to increase use of and conversion to the tax return preparation system, according to various embodiments.

### SUMMARY

Embodiments of the present disclosure address some of the shortcomings associated with traditional consumer marketing techniques by adaptively providing personalized marketing experiences to potential customers and users of a tax return preparation system, to increase use of and conversion to the tax return preparation system. The disclosed software system determines likelihoods of user preferences for marketing experiences, such as email campaigns, online advertisements, product pricing, and customer support. The software system determines likelihoods of user preferences for marketing experiences by defining user segments from samples of user responses/actions to various marketing experiences. When the software system receives one or more new users, the software system uses the user characteristics of the new users to identify one or more segments that the new users belong to, and the software system provides personalized marketing experiences to the new users based on the user preferences of other users who have similar user characteristics as the new users. By delivering marketing experiences that align with the users' preferences, the disclosed system increases the likelihood of revenue generation for the service provider, makes more efficient use of service provider resources, and improves the likelihood of overall satisfaction with the service provider—even if the user does not decide to receive service provider services/software products.

The software system provides personalized marketing experiences by delivering different marketing experiences to the users of a segment of users, in order to validate the effectiveness of one marketing experience while testing the effectiveness of another marketing experience for the segment of users, according to one embodiment. Although multiple marketing experiences can be concurrently validated and tested with a single segment of users (e.g., group of users having similar user characteristics), the software system uses a type of A/B testing by adaptively providing a first marketing experience and a second marketing experience to two sub-segments or two sub-groups of a segment. The software system adaptively provides the first marketing experience to a dynamically established first percentage of a segment of users to validate the effectiveness of the first marketing experience on the first percentage of the segment of users, according to one embodiment. The software system concurrently provides the second marketing experiences to a dynamically established second percentage of the segment of user to test the effectiveness of the second marketing experiences on the second percentage of the segment of user, according to one embodiment. The first and second percentages are dynamically established because the software system increases one percentage while decreasing the other percentage as the software system establishes that one marketing experience is preferred over the other by the users of the segment of users. The software system determines user preferences for one marketing experience over another based on user actions, which include, but are not limited to, logging into a service provider system, completing a task, purchasing a product, filing a tax return, visiting a webpage, selecting a link/button in an email message, and the like, according to one embodiment.

Embodiments of the disclosed software system provide superior testing results over traditional A/B testing, while seamlessly integrating feedback from the A/B testing into the software system. Traditional A/B testing is inefficient. For example, traditional A/B testing allocates control conditions to 50% of a set of users as a control group and allocates experimental conditions to 50% of the set of users as an experimental group, without regard to the likelihood of satisfactory performance of the control conditions over the test conditions, or vice versa. The test conditions are typically set, until a critical confidence, e.g., 95% confidence, is reached. By contrast, the disclosed software system dynamically allocates and re-allocates control conditions and test conditions concurrently, to enable the software system to both test new marketing experience options while providing users with personalized marketing experiences that they are probabilistically likely to respond well to. As a result, more users of the software system are likely to be satisfied with the software system and are more likely to complete a predetermined/desired action (e.g., completing questions, visiting a sequence of web pages, file a tax return, etc.) because the users receive relevant and/or preferred marketing experiences sooner than the same users would with the implementation of traditional A/B testing techniques. The improvements in customer satisfaction and the increases in customers completing predetermined actions in the software system can result in increased conversions of potential customers to paying customers, which translates to increased revenue for service providers, according to one embodiment.

By providing personalized marketing experiences in software systems for software products, such as tax return preparation systems, implementation of embodiments of the present disclosure allows for significant improvement to the fields of electronic marketing, customer service, user experience, electronic tax return preparation, data collection, and data processing, according to one embodiment. As one illustrative example, by adaptively distributing marketing experiences to users based on the users' characteristics and based on distributive frequency rates (described below), embodiments of the present disclosure allows for targeted marketing, targeting customer recruitment, and targeted customer retention with a software system for a tax return preparation system or other software product with fewer processing cycles and less communications bandwidth because the users preferences are efficiently and effectively determined based on their characteristics. Implementation of the disclosed techniques reduces processing cycles and communications bandwidth because marketing content is selectively sent to users who are likely to positively respond/act to the marketing content, as opposed to sending marketing content to all potential customers in the world or in a country. In other words, by personalizing marketing experiences, global energy consumption can be reduced by reducing less-effective efforts, communications, and communications systems. As a result, embodiments of the present disclosure allow for improved processor performance, more efficient use of memory access and data storage capabilities, reduced communication channel bandwidth utilization, and therefore faster communications connections.

In addition to improving overall computing performance, by dynamically and adaptively providing personalized marketing experiences in software systems, implementation of embodiments of the present disclosure represent a significant improvement to the field of automated user experiences and, in particular, efficient use of human and non-human resources. As one illustrative example, by increasing personal preferences for marketing experiences and by reducing presentation of non-preferred/less-effective marketing experiences, the user can more easily comprehend and interact with digital marketing experience displays and computing environments, reducing the overall time invested by the user to the tax return preparation or other software system-related tasks. Additionally, selectively presenting marketing experiences to users, based on their user characteristics, improves and/or increases the likelihood that a potential customer will be converted into a paying customer because the potential customer receives confirmation that the software system or service provider appears to understand the particular user's needs and preferences, according to one embodiment. Consequently, using embodiments of the present disclosure, the user-received marketing experience is less burdensome, less impersonal, and more persuasive to potential customers, former customers, and current customers receiving the marketing experiences.

### BRIEF DESCRIPTION OF THE DRAWINGS

FIGS. 1A and 1B are graph diagrams of A/B testing techniques, in accordance with one embodiment.

FIG. 2 is a block diagram of an example architecture for adaptively providing personalized marketing experiences, in accordance with one embodiment.

FIG. 3 is a flow diagram of an example of a process for training and updating a user experience analytics model, according to one embodiment.

FIG. 4 is a diagram of an example of a tree diagram for defining at least part of a user experience analytics model, according to one embodiment.

FIG. 5 is a flow diagram of an example of a process for defining a user experience analytics model, in accordance with one embodiment.

FIG. 6 is a flow diagram of an example of a process for determining a stop probability, in accordance with one embodiment.

FIG. 7 is a flow diagram of an example of a process for computing the effective performance of a segment or sub-segment of users, in accordance with one embodiment.

FIG. 8 is a flow diagram of an example of a process for computing the effective performance of input estimates blended by Thompson Sampling, according to one embodiment.

FIG. 9 is a flow diagram of an example of a process for providing personalized marketing experiences to users from a software system, according to one embodiment.

FIG. 10 is a flow diagram of an example of a process for providing personalized marketing experiences to users from a software system, according to one embodiment.

FIGS. 11A and 11B are a flow diagram of an example of a process for providing personalized marketing experiences to users from a software system, according to one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for adaptively providing personalized marketing experiences to potential customers and users of a tax return preparation system, to increase use of and conversion to the tax return preparation system, according to various embodiments.

### Introductory System

Herein, a software system can be, but is not limited to, any data management system implemented on a computing system, accessed through one or more servers, accessed through a network, accessed through a cloud, and/or provided through any system or by any means, as discussed herein, and/or as known in the art at the time of filing, and/or as developed after the time of filing, that gathers/obtains data, from one or more sources and/or has the capability to analyze at least part of the data.

As used herein, the term software system includes, but is not limited to the following: computing system implemented, and/or online, and/or web-based, personal and/or business tax preparation systems; computing system implemented, and/or online, and/or web-based, personal and/or business financial management systems, services, packages, programs, modules, or applications; computing system implemented, and/or online, and/or web-based, personal and/or business management systems, services, packages, programs, modules, or applications; computing system implemented, and/or online, and/or web-based, personal and/or business accounting and/or invoicing systems, services, packages, programs, modules, or applications; and various other personal and/or business electronic data management systems, services, packages, programs, modules, or applications, whether known at the time of filling or as developed later.

Specific examples of software systems include, but are not limited to the following: TurboTax™ available from Intuit, Inc. of Mountain View, Calif.; TurboTax Online™ available from Intuit, Inc. of Mountain View, Calif.; QuickBooks™, available from Intuit, Inc. of Mountain View, Calif.; QuickBooks Online™, available from Intuit, Inc. of Mountain View, Calif.; Mint™, available from Intuit, Inc. of Mountain View, Calif.; Mint Online™, available from Intuit, Inc. of Mountain View, Calif.; and/or various other software systems discussed herein, and/or known to those of skill in the art at the time of filing, and/or as developed after the time of filing.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the term “production environment” includes the various components, or assets, used to deploy, implement, access, and use, a given software system as that software system is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement at least part of the software system in the production environment such as a data center, a cloud computing environment, a dedicated hosting environment, and/or one or more other computing environments in which one or more assets used by the application in the production environment are implemented; one or more computing systems or computing entities used to implement at least part of the software system in the production environment; one or more virtual assets used to implement at least part of the software system in the production environment; one or more supervisory or control systems, such as hypervisors, or other monitoring and management systems used to monitor and control assets and/or components of the production environment; one or more communications channels for sending and receiving data used to implement at least part of the software system in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement at least part of the software system in the production environment; one or more databases used to store data in the production environment; one or more internal or external services used to implement at least part of the software system in the production environment; one or more backend systems, such as backend servers or other hardware used to process data and implement at least part of the software system in the production environment; one or more software modules/functions used to implement at least part of the software system in the production environment; and/or any other assets/components making up an actual production environment in which at least part of the software system is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate at least part of the software system.

In various embodiments, one or more cloud computing environments are used to create, and/or deploy, and/or operate at least part of the software system that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given software system or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets within one or more cloud or traditional computing environments.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user experience display” includes not only data entry and question submission user interfaces, but also other user experience features provided or displayed to the user such as, but not limited to the following: data entry fields; question quality indicators; images; backgrounds; avatars; highlighting mechanisms; icons; and any other features that individually, or in combination, create a user experience, as discussed herein, and/or as known in the art at the time of filing, and/or as developed after the time of filing.

As used herein, the term “marketing experience” includes the use of one or more of a variety of user experience elements (e.g., graphical and/or audible user interface elements) directed to the recruitment, retention, and/or conversion of potential customers, former customers, current customers, and/or other types of users of a software system, e.g., a tax return preparation system. The marketing experience includes user experience features provided or displayed to the user include, but are not limited to, email messages, email content, advertisements, web pages, advertisements imbedded in web pages, pop-up windows, icons, content positioning, product pricing, product pricing discounts, customer service options, customer service offers, free offers for consultations with customer service representatives, user interfaces, images, assistance resources, backgrounds, avatars, highlighting mechanisms, audio media, video media, content positioning within an email message, advertisement, web page or other user interface, and any other features that individually, or in combination, create a marketing experience or other user experience, as discussed herein, and/or as known in the art at the time of filing, and/or as developed after the time of filing.

Herein, the term “party,” “user,” “user consumer,” “customer” and “potential customer” are used interchangeably to denote any party and/or entity that interfaces with, and/or to whom information is provided by, the disclosed methods and systems described herein, and/or a person and/or entity that interfaces with, and/or to whom information is provided by, the disclosed methods and systems described herein, and/or a legal guardian of person and/or entity that interfaces with, and/or to whom information is provided by, the disclosed methods and systems described herein, and/or an authorized agent of any party and/or person and/or entity that interfaces with, and/or to whom information is provided by, the disclosed methods and systems described herein. For instance, in various embodiments, a user can be, but is not limited to, a person, a commercial entity, an application, a service, and/or a computing system.

As used herein, the term “analytics model” or “analytical model” denotes one or more individual or combined algorithms or sets of equations that describe, determine, and/or predict characteristics of or the performance of a datum, a data set, multiple data sets, a computing system, and/or multiple computing systems. Analytics models or analytical models represent collections of measured and/or calculated behaviors of attributes, elements, or characteristics of data and/or computing systems.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein, the term “decision tree” denotes a hierarchical tree structure, with a root node, parent nodes, and children nodes. The parent nodes are connected to children nodes through edges, and edge logic between parent nodes and children nodes performs a gating function between parent nodes and children nodes to permit or block the flow of a path from a parent node to a child node. As used herein, a node is associated with a node action that a model or process performs on a data sample or on a set of data samples.

As used herein, the term “segment” denotes a portion, section, or subset of a set of users (i.e., a user set). A segment can include an entire set of users or a portion of a set of users. As used herein a segment or sub-segment denotes a portion, section, or subset of users who have one or more user characteristics (as defined/described below) in common.

As used herein, the term “distribution frequency rate” denotes decimal numbers, fractions, and/or percentages that represent an average quantity of traffic within a segment of users to which one or more marketing/user experiences are provided, with the software system. In alternative language, the term distribution frequency rate denotes decimal numbers, fractions, and/or percentages that represent an average quantity of traffic for a segment of users by which one or more marketing/user experiences are provided to a segment of users within a software system. For example, within a single segment of users, a first marketing experience A is provided to users with a first distribution frequency rate, a second marketing experience B is provided to users with a second distribution frequency rate, and the second distribution frequency rate is 1 minus the first distribution frequency rate, according to one embodiment and as disclosed further below.

### Hardware Architecture

Disclosed herein is a production environment for adaptively providing personalized marketing experiences to potential customers and users of a tax return preparation system, to increase use of and conversion to the tax return preparation system. The disclosed software system selects marketing experiences for delivery to users by applying the users' characteristics to a user experience analytics model, according to one embodiment. The user experience analytics model determines rates by which to distribute marketing experiences to segments of users to concurrently validate and test the effectiveness of marketing experiences among segments of users, according to one embodiment. The software system analyzes user actions/responses to the marketing experiences to update the user experience analytics model and to dynamically adapt the personalization of the marketing experiences, at least partially based on feedback from users, according to one embodiment.

Embodiments of the disclosed software system provide superior testing results over traditional A/B testing, while seamlessly integrating feedback from the A/B testing into the software system. Traditional A/B testing is inefficient. For example, traditional A/B testing allocates control conditions to 50% of a set of users as a control group and allocates experimental conditions to 50% of the set of users as an experimental group, without regard to the likelihood of satisfactory performance of the control conditions over the test conditions, or vice versa. The test conditions are typically set, until a critical confidence, e.g., 95% confidence, is reached. By contrast, the disclosed software system dynamically allocates and re-allocates control conditions and test conditions concurrently, to enable the software system to both test new marketing experience options while providing users with personalized marketing experiences that they are probabilistically likely to respond well to. As a result, more users of the software system are likely to be satisfied with the software system and are more likely to complete a predetermined/desired action (e.g., completing questions, visiting a sequence of web pages, file a tax return, etc.) because the users receive relevant and/or preferred marketing experiences sooner than the same users would with the implementation of traditional A/B testing techniques. The improvements in customer satisfaction and the increases in customers completing predetermined actions in the software system can result in increased conversions of potential customers to paying customers, which translates to increased revenue for service providers, according to one embodiment.

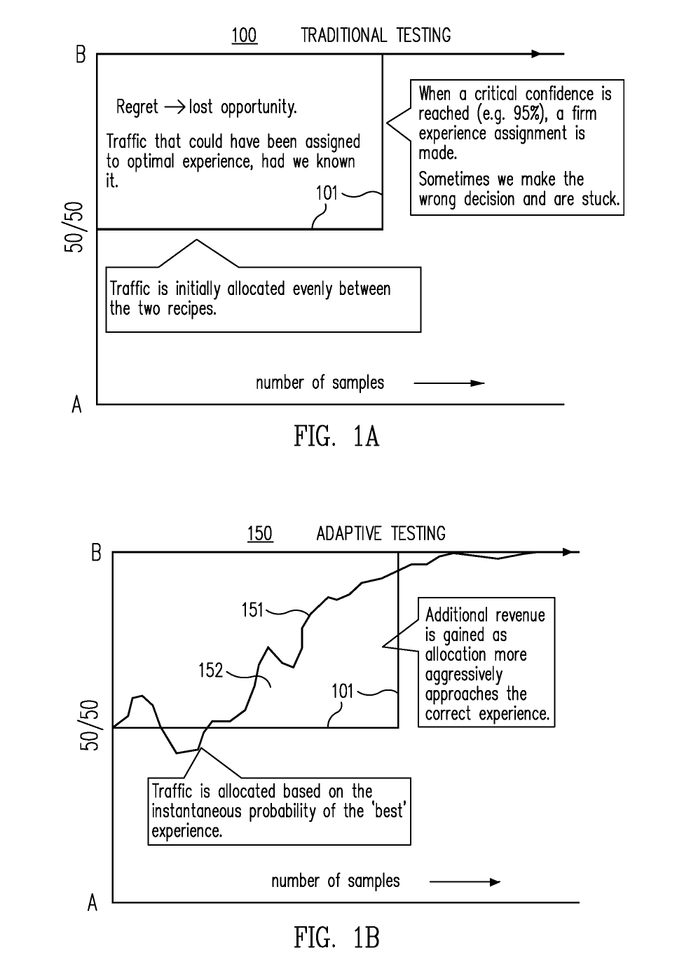

FIGS. 1A and 1B are graphical representations of some of the advantages of adaptive A/B testing over traditional A/B testing, according to one embodiment. FIG. 1A is an example of a graph 100 that illustrates delivery of a condition A to 50% of a user set and delivery of a condition B to 50% of the user set for a number of samples (x-axis), using traditional A/B testing techniques. Conditions A and B are equally distributed to the users of the user set until a critical confidence level is reached, e.g., 95%. After the critical confidence level is reached, traditional testing techniques switch to delivering the more successful of the conditions to 100% of the user set. In the graph 100, the test switches at a number of samples, represented by graph line 101, that were tested until a confidence level (e.g., 95%) was reached. Everything above and to the left of the graph line 101 represents lost opportunity to provide more condition B to the user set rather than condition A (which has ultimately been deemed inferior).

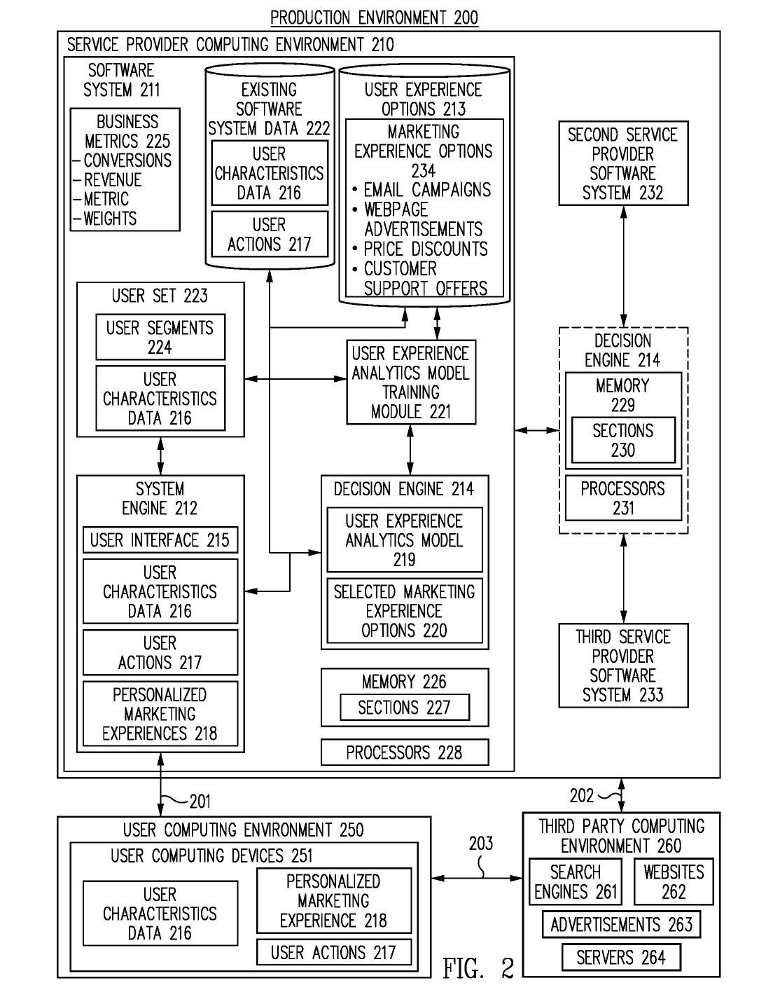

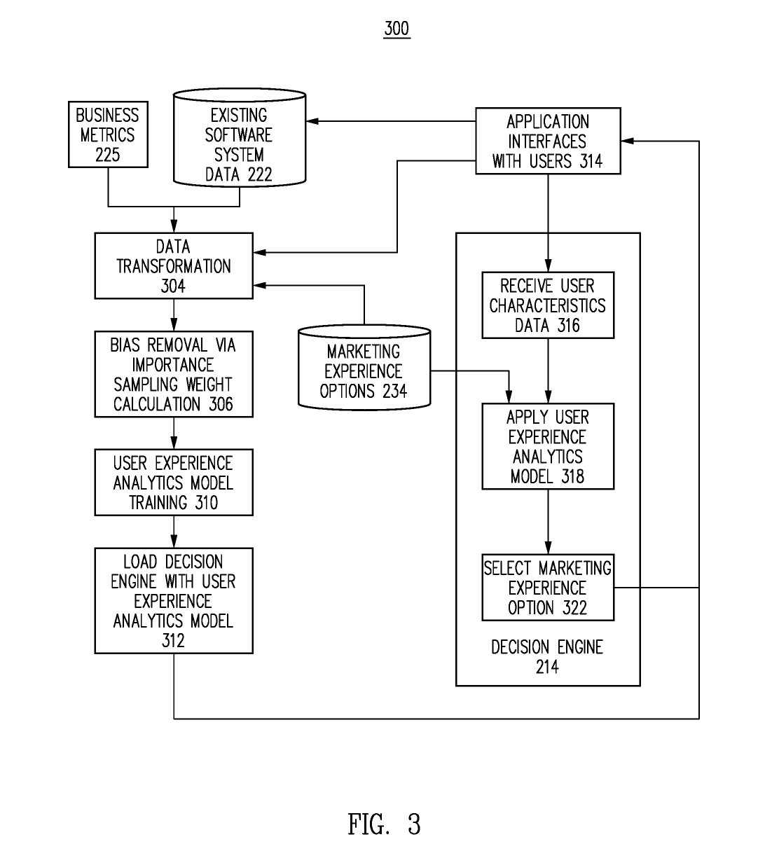

FIG. 1B shows a graph 150 that illustrates an adaptive delivery of condition A and condition B to the user set while determining which condition is superior to the other, according to one embodiment. The graph 150 includes a graph line 151 that represents a percentage of condition B that is allocated to the user set, according to one embodiment. The area 152 that is under the graph line 151 illustrates that more users of the user set receive condition B sooner by using adaptive A/B testing instead of the traditional A/B testing illustrated by FIG. 1A, according to one embodiment. Importantly, providing condition B sooner equates to providing more users with user experiences (e.g., marketing experiences) that are in accordance with user preferences and that are more likely to assist users in completing or accomplishing a particular activity (e.g., providing personal information, paying for a service, signing up as a service provider customer, staying logged in to a user session, complete filing a tax return, etc.), according to one embodiment. Thus, implementation of adaptive testing user experiences in a software system, as disclosed herein, translates to increases in quantities of satisfied customers, users performing desired actions, and improved revenue for the service provider of the software system, according to one embodiment. The systems and methods of FIGS. 2-11 disclose various embodiments that leverage the advantages of adaptive testing as described with respect to FIGS. 1A and 1B, according to one embodiment.

FIG. 2 illustrates an example embodiment of a production environment 200 for adaptively providing personalized marketing experiences to potential customers and users of a tax return preparation system, to increase use of and conversion to a tax return preparation system, according to one embodiment. The production environment 200 includes a service provider computing environment 210, a user computing environment 250, and third party computing environment 260 for adaptively delivering personalized marketing experiences to users of a software system, to cause the users to perform one or more particular actions (e.g., click a hyperlink in an email message, log into a software system service, purchase a software system service, answer a sequence of questions in a software system, continue use of a software system, file a tax return, etc.), according to one embodiment. The computing environments 210, 250, and 260 are communicatively coupled to each other with communication channels 201, 202, and 203, according to one embodiment.

The service provider computing environment 210 represents one or more computing systems such as, but not limited to, a server, a computing cabinet, and/or distribution center that is configured to receive, execute, and host one or more applications for access by one or more users, e.g., customers and/or potential customers of the service provider, according to one embodiment. The service provider computing environment 210 represents a traditional data center computing environment, a virtual asset computing environment (e.g., a cloud computing environment), or a hybrid between a traditional data center computing environment and a virtual asset computing environment, to host one or more software systems, according to one embodiment. The one or more software systems can include, but are not limited to tax return preparation systems, other financial management systems, and applications that support the tax return preparation systems and/or the other financial management systems, according to one embodiment. The service provider computing environment 210 includes a software system 211 that adaptively provides personalized marketing experiences by defining segments of users, associating customers/potential customers with one or more segments based on the user characteristics of the customers/potential customers, and delivering marketing experiences to the customers/potential customers in accordance with distribution frequency rates, according to one embodiment. By adaptively providing personalized marketing experiences, the software system 211 improves a likelihood that a customer/potential customer will perform a particular action or desired action, increases the likelihood of generating more service provider revenue, and further refines user preferences for defined segments of users, while concurrently, automatically, and seamlessly increasing the likelihood of receiving user traffic to the software system 211, according to one embodiment. The software system 211 includes various components, databases, engines, modules, and data to support adaptively providing personalized marketing experiences to users of the software system 211, according to one embodiment. The software system 211 includes a system engine 212, user experience options 213, and a decision engine 214, according to one embodiment.

The system engine 212 is configured to communicate information between the software system 211, the user computing environment 250, and/or the third party computing environment 260, according to one embodiment. The system engine 212 executes/hosts a user interface 215 to receive user characteristics data 216 and user actions 217 from the user computing environment 250 and/or from the third party computing environment 260, according to one embodiment. The user characteristics data 216 are collected from a customer, potential customer, or other user when the customer, potential customer, or other user interacts with the software system 211, the third party computing environment 260, and/or other software system for the service provider, according to one embodiment. The software system 211 generates personalized marketing experiences 218, at least partially based on the user characteristics data 216 that are received, and the software system 211 collects user actions 217 from the customer, potential customer, or other user to evaluate the effectiveness of the personalized marketing experiences 218 to influence the actions of a user. In one embodiment, the user interface 215 is used to display, provide, and/or otherwise deliver the one or more of a variety of marketing experience options in the personalized marketing experiences 218. The user interface 215 includes one or more user experience elements and graphical user interface tools, such as, but not limited to, buttons, slides, dialog boxes, text boxes, drop-down menus, banners, tabs, directory trees, links, audio content, video content, other multimedia content for communicating information to the user and for receiving the information from users, email messages, webpage banners, webpage content, email message content, price discounts, customer service content, customer service offers, electronic communication tools/content that support customer service offers, and the like, according to one embodiment.

The system engine 212 and/or the software system 211 communicate with users through the user computing environment 250, according to one embodiment. The user computing environment 250 includes user computing devices 251 that are representative of computing devices or computing systems used by users (e.g., customer and potential customers) to access, view, operate, and/or otherwise interact with the software system 211, according to one embodiment. The term “users” and “user computing devices” are used interchangeably to represent the users of the software system 211, according to one embodiment. Through the user computing devices 251, the software system 211 collects the user characteristics data 216 and the user actions 217, according to one embodiment.

The system engine 212 and/or the software system 211 communicate with users through the third party computing environment 260, according to one embodiment. The third party computing environment 260 includes one or more servers 264 for providing/supporting one or more search engines 261 and/or one or more websites 262, according to one embodiment. The service provider computing environment 210 and/or the software system 211 is configured to communicate with the third party computing environment 260 to cause the third party computing environment 260 to display one or more advertisements 263 or other implementations of the personalized marketing experiences 218, according to one embodiment. The third party computing environment 260 displays one or more advertisements 263 in response to user characteristics data 216 collected about users by the third party computing environment 260 while/after users submit queries to the search engines 261 and/or while after users visit the websites 262, according to one embodiment.

The user characteristics data 216 represents user characteristics for customers, potential customers, or other users targeted by the software system 211, according to one embodiment. The user characteristics data 216 can include information from existing software system data 222, such as one or more previous years' tax return data for users in addition to data representing previous user interactions with the software system 211. The user characteristics data 216 is stored in a data store, a database, and/or a data structure, according to one embodiment. The user characteristics data 216 also includes information that the software system 211 gathers directly from one or more external sources such as, but not limited to, a webpage host/server, a search engine host/server, a payroll management company, state agencies, federal agencies, employers, military records, public records, private companies, and the like, according to one embodiment. Additional examples of the user characteristics (represented by the user characteristics data 216) include, but are not limited to, data indicating user computing system characteristics (e.g., browser type, applications used, device type, operating system, etc.), data indicating time-related information (hour of day, day of week, etc.), data indicating geographical information (latitude, longitude, designated market area region, etc.), data indicating external and independent marketing segments, data identifying an external referrer of the user (e.g., paid search, ad click, targeted email, etc.), data indicating a number of visits made to a service provider website, data indicating a user's name, data indicating a Social Security number, data indicating government identification, data indicating a driver's license number, data indicating a date of birth, data indicating an address, data indicating a zip code, data indicating a home ownership status, data indicating a marital status, data indicating an annual income, data indicating a job title, data indicating an employer's address, data indicating spousal information, data indicating children's information, data indicating asset information, data indicating medical history, data indicating occupation, data indicating information regarding dependents, data indicating salary and wages, data indicating interest income, data indicating dividend income, data indicating business income, data indicating farm income, data indicating capital gain income, data indicating pension income, data indicating IRA distributions, data indicating unemployment compensation, data indicating education expenses, data indicating health savings account deductions, data indicating moving expenses, data indicating IRA deductions, data indicating student loan interest deductions, data indicating tuition and fees, data indicating medical and dental expenses, data indicating state and local taxes, data indicating real estate taxes, data indicating personal property tax, data indicating mortgage interest, data indicating charitable contributions, data indicating casualty and theft losses, data indicating unreimbursed employee expenses, data indicating alternative minimum tax, foreign tax credit, data indicating education tax credits, data indicating retirement savings contribution, data indicating child tax credits, data indicating residential energy credits, and any other information that is currently used, that can be used, or that may be used in the future, in a financial system, or in the preparation of a user's tax return, according to various embodiments.

In one embodiment, the service provider computing environment 210, the software system 211, and/or the third party computing environment 260 determines one or more of the users' characteristics that are represented by the user characteristics data 216.

The system engine 212 populates the personalized marketing experiences 218 with one or more user experience options 213, according to one embodiment. The user experience options 213 include marketing experience options 234, which include, but are not limited to, email campaigns, webpage advertisements, price discounts, and customer support services, according to one embodiment.

The marketing experience options 234 include email campaigns that are sent to customers or potential customers to promote the use of or return to services provided by the service provider computing environment, according to one embodiment. The software system 211 uses email messages in personalized marketing experiences 218 in order to follow up with customers or potential customers who logged into or initiated a user session with a tax return preparation system or other software system or service provided by a service provider or by the service provider computing environment 210, according to one embodiment. For example, if a user provides his/her email address and some personal information (i.e., user characteristics data) in a tax return preparation system, the software system 211 determines the likely preferences for the user based on the user's personal information and delivers a personalized email message (i.e., one type of a personalized marketing experience) to the user to persuade the user to log back into and/or complete a task in the tax return preparation system (or other software system or service), according to one embodiment.

The marketing experience options 234 include email campaigns or messages for prior customers (e.g., customers during one or more previous years), to persuade the users to become returning customers, according to one embodiment. The software system 211 uses existing software system data, such as user characteristics data 216, which has been collected from the potential return customers in prior years to determine user preferences and to generate personalized email messages for the potential returning customers.

The software system 211 selects content, layout, transmission time of the year, transmission time of the month, transmission day of the week, transmission frequency, time of the day of transmission, location of the user interface elements, content phrasing/framing, which features to display, color scheme, whether to include offers of assistance or customer support, whether to include pricing information, whether to include a pricing discount, how much of a pricing discount to include, which types/segments of users to target with the email messages, and other email campaign features for users based on the segment that users are associated with, to provide content that is likely to correspond with the users' personal preferences, according to one embodiment. Techniques for identifying one particular marketing/email experience over another for a user is disclosed below in detail.

The marketing experience options 234 include webpage advertisements displayed in, for example, a webpage, at least partially based on the segment of users that the user is associated with (e.g., based on the user's user characteristics data 216), according to one embodiment. The software system 211 provides personalized marketing experiences 218 to the third party computing environment 260 for the third party computing environment 260 to display as advertisements 263, according to one embodiment. The software system 211 coordinates with the third party computing environment 260 to display the advertisements 263 in response to queries submitted by users to one or more search engines 261 and/or in response to users viewing one or more websites 262, according to one embodiment. In one embodiment, the advertisements 263 are displayed in a pop-up window and/or as a discount coupon. In one embodiment, the advertisements 263 are displayed on particular websites 262 (e.g., news websites, financial management websites, etc.). In one embodiment, the advertisements 263 are displayed to users based on user characteristics data 216 collected from the users during the users' interaction with or visit to one or more of the search engines 261 and/or websites 262. In one embodiment, the third party computing environment 260 includes one or more computing systems or algorithms that tag/identify users for receipt of one or more price discounts, product advertisements, and the like, based on the user characteristics data 216 collected from the users by the third party computing environment 260.

The marketing experience options 234 include, but are not limited to, price discounts offered to users, at least partially based on the users' user characteristics data 216 and based on the segments of users with which the users are associated, according to one embodiment. The software system 211 uses a user experience analytics model to determine what price point a user is likely to prefer or accept in purchasing a service from the service provider (e.g., purchasing use of a tax return preparation system). Based on the most expensive price (or the smallest discount), the software system 211 is configured to determine return on investment of providing a particular price point to a particular user or segment of users prior to actually offering or providing discounted product prices to the particular user or segment of users, according to one embodiment. The identified price discounts are offered to customers, potential customers, or other users through an email campaign, through third party advertisements, through customer support communications, and/or during use of a service provider product/service (e.g., through a pop-up coupon), according to one embodiment. For segments of users who are unlikely to purchase a service provider service unless the service is heavily discounted, it may be more advantageous for the service provider to walk away from the potential business of those particular segments of users because the return on invested resources (e.g., computing resources and human resources) is a net loss for the service provider, according to one embodiment. By identifying the price point at which segments of users are willing to purchase a product or service, the software system 211 substantially avoids wasting potential revenue by not charging a customer or potential customer as much as the customer or potential customer is willing to pay (based on the actions of the segment of users with which the customer or potential customer is associated with), according to one embodiment.

The software system 211 uses a user experience analytics model to determine additional metrics by which the software system 211 determines a price point or a price discount to offer to users, according to one embodiment. In one embodiment, the software system 211 determines likelihood of login rates, likelihood of conversion rates (i.e., conversion to paying customer), and likelihood of loss of customer rates, in response to price discount offers and based on defined segments of users. The software system 211 can then be configured to determine which price discounts to offer to particular segments of users to increase, improve, maximize, and/or probabilistically optimize profits/revenue gained by selectively offering price discounts for a particular service provider service/product, according to one embodiment.

The marketing experience options 234 include customer service offers provided to users, at least partially based on the users' user characteristics data 216 and based on the segments of users with which the users are associated, according to one embodiment. Customer service offers include, but are not limited to, offering audio, digital, or other live communications with customer support representatives to assist the user in completing a task, such as preparing or filing a tax return with a tax return preparation system, according to one embodiment. Customer support representatives can be trained and/or certified professionals such as certified public accountants, accountants, tax preparation specialists, information technologists, and/or service provider accredited self-trained assistants, in one embodiment. The software system 211 uses a user experience analytics model to determine which customer service offers a user is likely to prefer or be persuaded by before purchasing a service from the service provider (e.g., purchasing use of a tax return preparation system). Because connecting a customer or potential customer with a live customer support representative can cost the service provider $20.00 or more per customer support session, the software system 211 is configured to determine a return on investment of providing a customer support offers to a particular user or segment of users, prior to actually providing customer support offers to the particular user or segment of users, according to one embodiment. The customer support offers are provided to customers, potential customers, or other users through an email campaign, through third party advertisements, through customer support communications, and/or during use of a service provider product/service (e.g., through a pop-up coupon), according to one embodiment. For segments of users who are unlikely to purchase a service provider service in spite of receiving assistance from a customer support representative, the software system 211 may determine that it is more advantageous for the service provider to walk away from the potential business of those particular segments of users because the return on invested resources (e.g., computing resources and human resources) is a net loss for the service provider, according to one embodiment.

In one embodiment, the software system 211 identifies segments of users, for providing customer service offers to, based on the likelihood that the segments of users will experience Fear, Uncertainty, and/or Doubt (“FUD”) regarding the preparation of their tax returns or regarding some other task that the service provider can offer a service to assist users with. Because some users value accuracy or quality more than price, the offer of a lower price may not be their preference or may not be motivating to them. By employing a user experience analytics model to identify users who are likely to experience FUD for a given task, the software system 211 can identify segments of users who can be profitably provided with customer service offers and assistance, according to one embodiment.

The user experience options 213 also include, but are not limited to, predictive and analytics models that can be used to determine relevant topics to present to the user; questions to present to the user; sequences of topics to present to the user; sequences of questions to present to the user; and the like, according to one embodiment. The user experience options 213 also include, but are not limited to, questions, webpages, sequences of pages, colors, interface elements, positioning of interface elements within webpages, promotions that can be offered to users, audio files, video files, other multimedia, and the like, according to various embodiments.

In addition to determining the content and/or features of the marketing experience options 234 to provide to users, the software system 211 also determines which type of marketing experience options 234 to provide to users, at least partially based on the users' user characteristics data 216 and based on the segments of users with which the users are associated, according to one embodiment. For example, the software system 211 is configured to identify customer support offers as a preferred marketing offer for a first segment of users and is configured to identify email messages or price discounts as a preferred marketing offer for a second segment of users.

Recipients of the personalized marketing experiences 218 have individual preferences, technical competency levels, levels of education, levels of comfort using digital technologies, and other distinctive or individual characteristics that increase the value of personalized marketing experiences, as provided by the software system 211. To improve the likelihood of satisfaction of the user with the received personalized marketing experiences 218, the system engine 212 selectively applies one or more of the marketing experience options 234 to the personalized marketing experiences 218 while facilitating interactions between the software system 211 and the users, according to one embodiment.

The software system 211 uses the decision engine 214 to identify which marketing experience options 234 to apply to the personalized marketing experiences 218, in order to facilitate or promote one or more particular user actions (e.g., such as completing a set of questions, logging into a software system, purchase a service, filing a tax return with software system, etc.), according to one embodiment. The decision engine 214 is configured to receive the user characteristics data 216, receive the marketing experience options 234, and select one or more of the marketing experience options 234 for the system engine 212 to integrate into the personalized marketing experiences 218 for delivery to customers, potential customers, and/or other users, according to one embodiment.

The decision engine 214 applies the user characteristics data 216 and the marketing experience options 234 to a user experience analytics model 219, to determine which marketing experience options 234 to apply to users with particular user characteristics, according to one embodiment. The user experience analytics model 219 returns distribution frequency rates for marketing experience options 234, based on the user characteristics data 216, according to one embodiment. The distribution frequency rates define a frequency with which users having particular user characteristics are provided with particular marketing experience options 234, according to one embodiment. In one embodiment, users are directed to particular marketing experience options, for example, via a universal resource locator (“URL”). In one embodiment, selected marketing experience options are delivered to users by modifying the content of personalized marketing experiences 218. The phrase “directing users to marketing experience options” is used interchangeably with “providing users with marketing experience options,” according to one embodiment.

The decision engine 214 uses the distribution frequency rates from the user experience analytics model 219 to generate a weighted pseudo-random number that represents the one or more marketing experience options that are to be provided to a user based on the user's user characteristics data 216, according to one embodiment. Examples of distribution frequency rates include 0.2 for a first marketing experience option, 0.5 for a second marketing experience option, and 0.3 for a combination of one or more other marketing experience options, according to one embodiment. In practice, 0.2, 0.5, and 0.3 distribution frequency rates mean that for a particular user characteristic, 2 out of 10 users receive the first marketing experience option, 5 out of 10 users receive the second marketing experience option, and 3 out of 10 users receive the combination of one or more other marketing experience options, according to one embodiment. The decision engine 214 uses the distribution frequency rates and the weighted pseudo-random number to identify selected marketing experience options 220, for delivery to the user, according to one embodiment.

While the marketing experience options 234 are described as experience elements/features that are added to the personalized marketing experiences 218, the selected marketing experience options 220 can also include the omission of one or more marketing experience options 234. For example, the user experience analytics model 219 can be configured to generate distribution frequency rates of 0.8 and 0.2 for determining whether or not to display large icons in an email message, according to whether the age, income level, employment status, education level, or other user characteristic is above or below one or more thresholds that are set within the user experience analytics model 219, according to one embodiment. In other words, the output of the user experience analytics model 219 can be Boolean and can simply determine whether a user receives a particular marketing experience option or not, based on the user's user characteristics, according to one embodiment.

The software system 211 uses, executes, and/or operates a user experience analytics model training module 221 to train (e.g., initialize and/or update) the user experience analytics model 219, according to one embodiment. The user experience analytics model training module 221 retrieves user characteristics data 216 from the existing software system data 222 and retrieves marketing experience options 234 and/or other user experience options 213 for use in training the user experience analytics model 219, according to one embodiment. The user experience analytics model training module 221 initializes and/or updates the user experience analytics model 219 using techniques that include, but are not limited to, decision trees, regression, logistic regression, artificial neural networks, support vector machines, linear regression, nearest neighbor methods, distance based methods, Naive Bayes, linear discriminant analysis, k-nearest neighbor algorithm, and/or another mathematical, statistical, logical, or relational algorithms to determine correlations and/or other relationships between the user characteristics data and the performance of marketing experience options on segments of users, according to one embodiment.

In one embodiment, the user experience analytics model training module 221 defines a user set 223 that is based on all or part of the users that have interacted with the software system 211 and/or for whom user characteristics data 216 has been gathered or received. The user experience analytics model training module 221 defines a number of user segments 224 around subsets/groups of users who share some of the same user characteristics, which are represented by the user characteristics data 216. In other words, the user segments 224 are subsets of the user set 223, and each of the user segments 224 represent users who have one or more user characteristics in common with other users in a particular one of the user segments 224, according to one embodiment.

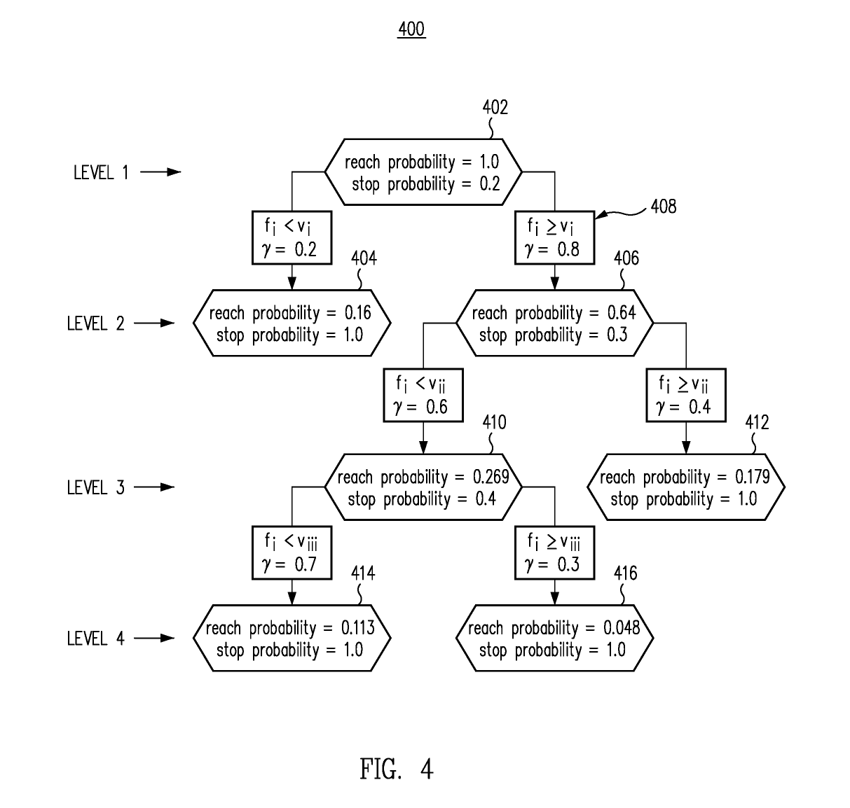

The user experience analytics model training module 221 trains the user experience analytics model 219 by generating a decision tree, based on how particular marketing experience options 234 perform with particular user segments 224, according to one embodiment. The user experience analytics model training module 221 generates a decision tree as part of the analytics logic for the user experience analytics model 219, to facilitate generating distribution frequency rates. The processes 300, 500, 600, 700, 800, 900, 1000, and 1100, of FIGS. 3, 5, 6, 7, 8, 9, 10, and 11A-11B, respectively, disclose particular embodiments that may be used by the user experience analytics model training module 221 for initializing and/or updating the user experience analytics model 219, according to one embodiment.

The software system 211 adapts the personalized marketing experiences and/or the user experience analytics model 219 and/or the user segments 224 based on the user actions 217 received from users, to dynamically and adaptively improve the personalized marketing experiences 218, according to one embodiment. As described above, the user actions 217 include, but are not limited to, reading an email message, selecting a hyperlink in an email message, following instructions provided in an email message, logging into a software system (e.g., tax return preparation system), purchasing a service, filing a tax return, responding to questions, using a software system, remaining on a webpage, hovering over a user interface element (e.g., a hyperlink) in a webpage, clicking/selecting a user interface element (e.g., a hyperlink, a banner, a picture, etc.), contacting customer support, and engaging in web-based or telephonic communication with customer support, according to one embodiment. The software system 211 is configured to store/update user characteristics data 216 and user actions 217, in the existing software system data 222, during the operation of the software system 211. After a predetermined period of time, such as, but not limited to, an hour, a day, semi-weekly, weekly, biweekly, and the like, the user experience analytics model training module 221 retrieves the marketing experience options 234, the user characteristics data 216, the user actions 217, and the business metrics 225 to determine the performance of the marketing experience options 234 and to update the user experience analytics model 219, based on the performance of the marketing experience options 234, according to one embodiment. Particular embodiments for initializing and/or updating the user experience analytics model 219 are disclosed below in the processes 300, 500, 600, 700, 800, 900, 1000, and 1100, and in the corresponding FIGS. 3, 5, 6, 7, 8, 9, 10, and 11A-11B, respectively, according to one embodiment.

The business metrics 225 include, but are not limited to, the various metrics used by the software system 211 and/or the service provider of the software system 211 to evaluate the success, failures and/or the performance of the marketing experience options 234, according to one embodiment. The business metrics 225 include, but are not limited to, number of conversions of users from potential customers to paying customers, the percentage of conversions of potential customers to paying users, quantities of revenue, rates of revenue collected per user (e.g., average revenue collected per user), increases/decreases in revenue as compared to one or more previous years, months, weeks, days, and metric weights that are applied to conversions and revenues to establish a relative importance of conversions verses revenue generation. The business metrics 225 can also include records of other actions taken by users, such as, but not limited to, numbers of questions answered, duration of use of the software system 211, number of pages or user experience displays visited within a software system 211, use of customer support, and the like, according to one embodiment.

The software system 211 includes memory 226 that has one or more sections 227 allocated for the operation or support of the software system 211, according to one embodiment. For example, the memory 226 and/or the one or more sections 227 are allocated to the storing and/or processing of: user characteristics data 216, user actions 217, the user experience analytics model 219, the user experience analytics model training module 221, and the like, according to one embodiment. The software system 211 also includes one or more processors 228 configured to execute and/or support the operations of the software system 211, according to one embodiment.

In one embodiment, the decision engine 214 is integrated into the software system 211 to support operation of the software system 211. In one embodiment, the decision engine 214 is hosted in the service provider computing environment 210 and is allocated computing resources, e.g., memory 229 having sections 230, and one or more processors 231, that differ from some of the computing resources of the software system 211. The decision engine 214 is hosted in the service provider computing environment 210 in order to provide support for the software system 211, in addition to providing support for a second service provider software system 232 and/or a third service provider software system 233, according to one embodiment. Although a second service provider software system 232 and a third service provider software system 233 are illustrated and described herein, the decision engine 214 can be configured to operationally support fewer or more software systems, according to various embodiments. In one embodiment, the software system 211 is a tax return preparation system. In one embodiment, the software system 211 is marketing software system and the second service provider software system 232 is a tax return preparation system.

The user experience analytics model training module 221 initializes and/or updates the user experience analytics model 219 from a backend or off-line system, rather than as an integrated online process, according to one embodiment. For example, rather than sharing memory and processor resources with the software system 211, the user experience analytics model training module 221 is allocated dedicated memory and processor resources to facilitate secure and more timely processing of user characteristics of new and existing software system data, and of marketing experience options for training the user experience analytics model 219. In another embodiment, the user experience analytics model training module 221 is integrated into the software system 211, as illustrated, and shares one or more hardware resources with the decision engine 214, within the service provider computing environment 210, according to one embodiment.

In one embodiment, the user characteristics data 216 includes information collected about users from one or more external sources of user data, which is used by the software system 211 to define user segments 224, to identify preferred marketing experience options 234 for a user, to train the user experience analytics model 219, and/or to generate the personalized marketing experiences 218. For example, after receiving initial user-identifying user characteristics data 216, the software system 211 is configured to determine (from third party or external data sources) whether the user is a home owner, whether the user is employed, whether the user has been imprisoned, whether the user has children, the type of job the user has, an average income for the type of employment of the user, average home value in the user's zip code, marital status of the user, whether the user maintains public social media accounts, whether the user was directed from or selected a paid-for link/advertisement, whether the user was directed from social media, or the like. The software system 211 uses externally acquired information about a user to determine which one or more user segments 224 the user is associated with, to generate personalized marketing experiences 218 for the user that the user is likely to prefer, according to one embodiment.

By providing personalized marketing experiences in software systems for software products, such as tax return preparation systems, implementation of embodiments of the present disclosure allows for significant improvement to the fields of electronic marketing, customer service, user experience, electronic tax return preparation, data collection, and data processing, according to one embodiment. As one illustrative example, by adaptively distributing marketing experiences to users based on the users' characteristics and based on distributive frequency rates (described below), embodiments of the present disclosure allows for targeted marketing, targeting customer recruitment, and targeted customer retention with a software system for a tax return preparation system or other software product with fewer processing cycles and less communications bandwidth because the users preferences are efficiently and effectively determined based on their characteristics. Implementation of the disclosed techniques reduces processing cycles and communications bandwidth because marketing content is selectively sent to users who are likely to positively respond/act to the marketing content, as opposed to sending marketing content to all potential customers in the world or in a country. In other words, by personalizing marketing experiences, global energy consumption can be reduced by reducing less-effective efforts, communications, and communications systems. As a result, embodiments of the present disclosure allow for improved processor performance, more efficient use of memory access and data storage capabilities, reduced communication channel bandwidth utilization, and therefore faster communications connections.

In addition to improving overall computing performance, by dynamically and adaptively providing personalized marketing experiences in software systems, implementation of embodiments of the present disclosure represent a significant improvement to the field of automated user experiences and, in particular, efficient use of human and non-human resources. As one illustrative example, by increasing personal preferences for marketing experiences and by reducing presentation of non-preferred/less-effective marketing experiences, the user can more easily comprehend and interact with digital marketing experience displays and computing environments, reducing the overall time invested by the user to the tax return preparation or other software system-related tasks. Additionally, selectively presenting marketing experiences to users, based on their user characteristics, improves and/or increases the likelihood that a potential customer will be converted into a paying customer because the potential customer receives confirmation that the software system or service provider appears to understand the particular user's needs and preferences, according to one embodiment. Consequently, using embodiments of the present disclosure, the user-received marketing experience is less burdensome, less impersonal, and more persuasive to potential customers, former customers, and current customers receiving the marketing experiences.

### Process

FIG. 3 illustrates a process 300 for training (e.g., initializing and/or updating) the user experience analytics model 219, as described above, according to one embodiment.

At operation 304, the process performs data transformation, to prepare existing software system data 222 and data representing business metrics 225 for processing, according to one embodiment. The process performs data transformation on the existing software system data 222 (inclusive of user characteristics data and user actions), on marketing experience options 234, and on business metrics 225. Data transformation includes, but is not limited to, formatting, rearranging, organizing, ranking, and/or prioritizing the data to enable it to be uniformly processed or analyzed by one or more equations and/or algorithms, according to one embodiment. Operation 304 proceeds to operation 306, according to one embodiment

At operation 306, the process performs bias removal via importance sampling weight calculation, according to one embodiment. The process performs bias removal on the business metrics, such as conversions and revenue, as well as on user actions and/or responses for the existing software system data 222 to account for particular user characteristics that were targeted, that are different, or that otherwise bias the user responses and/or the business metrics, according to one embodiment. Operation 306 proceeds to operation 310, according to one embodiment

At operation 310, the process performs user experience model training, according to one embodiment. The process uses the same algorithm to initialize and to update the user experience analytics model, according to one embodiment. The process trains the user experience analytics model by using techniques that include, but are not limited to, regression, logistic regression, decision trees, artificial neural networks, support vector machines, linear regression, nearest neighbor methods, distance based methods, Naive Bayes, linear discriminant analysis, k-nearest neighbor algorithm, and/or another mathematical, statistical, logical, or relational algorithms to determine correlations and/or other relationships between the user characteristics data and the performance of marketing experience options for segments of users, according to one embodiment.

In one embodiment, training a user experience analytics model includes defining a decision tree, which defines how a segment of users is defined, based on user characteristics and the performance of one or more marketing experience options among users who commonly share one or more user characteristics. Operation 310 proceeds to operation 312, according to one embodiment

In one embodiment, the process 300 performs user experience model training by creating, validating, and/or modifying a decision tree. FIG. 4 illustrates an example of a decision tree 400 that can be used to determine at least part of the algorithm, logic, and/or function of the user experience analytics model that selects which marketing experience options to deliver to users based on user characteristics, to facilitate generating personalized marketing experiences in the software system 211. The decision tree 400 includes nodes 402, 404, 406, 410, 412, 414, and 416 (collectively, nodes 402-416) connected together through edges and edge logic. The edge logic defines the rules and parameters for traversing from a parent node to a child node in the decision tree 400, according to one embodiment. Each of the nodes 402-416 includes node properties, such as a reach probability, a stop probability, a marketing experience option, and a user segment.

The reach probability is the probability that a user's characteristics (being applied to the logic of the decision tree) will reach a particular node, according to one embodiment. Because all users are evaluated by the node 402, the reach probability of the node 402 is 1, indicating that there is a 100% chance that a user's characteristics will be evaluated by the node 402. Node 404 has an example reach probability of 0.16 and node 406 has an example reach probability of 0.64. Accordingly, of all the user traffic that is applied to the decision tree 400, node 404 will receive (for example) 16% of the user traffic and node 406 will receive (for example) 64% of the user traffic, on average, according to one embodiment. Because each node is assigned at least one user experience option, and because the reach probabilities of the nodes 402-416 indicate the frequency with which a marketing experience option is provided to users of a user segment, the reach probabilities are the distribution frequency rates described in the production environment 200. In other words, the reach probabilities determine a frequency rate by which to distribute user experience options to users of user segments, based on the users' characteristics, according to one embodiment.

In one embodiment, the reach probabilities indicate the likelihood of all users being assigned to a particular segment, and the nodes (e.g., 404) represent a segment of users—to which two different personalized marketing experiences are provided with distribution frequencies (e.g., 20% of users of the segment of users receive a first personalized marketing experience and 80% of users of the segment of users receive a second personalized marketing experience).

The stop probability is the probability that the performance of a particular node without children nodes (for a user segment) will be better than the performance of children nodes split from the particular node, according to one embodiment. In other words, the stop probability is the probability that the performance of a leaf node is greater than the performance of creating two children nodes from a leaf node to convert the leaf node to a parent node. If a stop probability is 1, then the probability of stopping the further evaluation of the data sample is 100%. If a stop probability is less than 1, then the stop probability represents a likelihood that the decision tree will apply the marketing experience option of the current node to a segment of users, rather than evaluating a further path through the nodes of the decision tree 400, according to one embodiment.

At least one marketing experience option is assigned to be provided to each segment of users that is represented by each node of the decision tree 400. In one embodiment, a marketing experience option is one or more of an email campaign, one or more features/characteristics of email messages within an email campaign, content in an email message, content of an advertisement in a webpage, the location of an advertisement in a webpage, other features/characteristics of an advertisement in a webpage, pricing quantity/characteristics for use of a service provided by a service provider, features/characteristics/content of customer support offers, and the like. In one embodiment, the user experience analytics model includes a different decision tree for each marketing experience option, and each of the nodes in the decision tree represent a binary decision to apply or to not apply a marketing experience option to a user's personalized marketing experience. In one embodiment, the user experience analytics model includes a different decision tree for each user characteristic, and each of the nodes in the decision tree represent the application of one of a number of marketing experience options to a user's personalized marketing experience. In one embodiment, the user experience analytics model includes a decision tree having edge logic that evaluates different user characteristics and each node of the decision tree represent a different segment of users to which two or more marketing experience options are applied with distribution frequency rates.

A user segment is a segment or portion of users who have at least one user characteristic in common. For example, a user set can be bifurcated into two user segments, in which a first user segment includes users who are younger than 30 years old and the second user segment includes users who are at least 30 years old, according to one embodiment.

Each of the nodes 402-416 belong to a level that is defined by 1 plus the number of connections between the node of interest and the root node. Because the root node is the top node in the decision tree 400, the root node for the decision tree 400 is the node 402. Accordingly, node 402 belongs to level 1, nodes 404 and 406 belong to level 2, nodes 410 and 412 belong to level 3, and nodes 414 and 416 belong to level 4 of the decision tree 400, according to one embodiment.

In one embodiment, the marketing experience options applied to a segment of users that is represented by a node is related to the level of the node in the decision tree 400. In one embodiment, all levels of one decision tree provide binary options for whether or not to apply a single marketing experience option to a user's personalized marketing experience. In one embodiment, each level of the decision tree is associated with a different marketing experience option, and each level of the decision tree provides binary options for whether or not to apply a marketing experience option associated with that level to a user's personalized marketing experience. In one embodiment, marketing experience options are applied to segments of users represented by the nodes within the decision tree, based on the dominance or capacity of the marketing experience option to affect the actions of users, with more dominant user experience options being assigned to nodes that are closer to the root node.

In one embodiment, edge logic includes an edge frequency (γ) for which a single user characteristic (fᵢ) satisfies a threshold (vᵢ). The edge logic provides rules and the average frequency by which data samples (including customer/potential customer user characteristics data) traverse parent nodes to children nodes. The edge logic 408 indicates that the probability of the user characteristic (fᵢ) being greater than or equal to the threshold (vᵢ) is 0.8, and that the probability of the user characteristic (fᵢ) being less than the threshold (vᵢ) is 0.2, according to one embodiment. The reach probability of a child node is the product of the edge frequency (γ) multiplied with the stop probability subtracted from one. For example, the reach probability of node 406 is 0.64 which is equal to (1−stop probability of node 402)*(γ=0.8). In one embodiment, the thresholds for descendent nodes are different than all ancestor nodes because each descendent node already satisfies or inherits all of the characteristics of the descendent node's ancestor nodes.

Returning to the process 300 of FIG. 3, at operation 312, the process loads the decision engine with the user experience analytics model, according to one embodiment. Operation 312 proceeds to operation 314, according to one embodiment.

At operation 314, an application interfaces with users, to gather user characteristics data for users, according to one embodiment. The application interfaces with users by collecting clickstream data, IP address information, location of the user, operating system used by the user, computing device type (e.g., phone, laptop, etc.), computing device brand (e.g., Apple, non-Apple, etc.), computing device operating system (e.g., OS X, Android, etc.), user computing device identifiers, and other user characteristics data, according to one embodiment. The application and the decision engine save business metrics, user characteristics data, and/or user actions as existing software system data 222, according to one embodiment. The term “application” is used interchangeably with the term “software system”, according to one embodiment. Operation 314 concurrently proceeds to operation 304 to update the user experience analytics model, and proceeds to operation 316 to apply the user experience analytics model to information directly and/or indirectly received about the users, according to one embodiment.

At operation 316, the decision engine 214 receives user characteristics data, according to one embodiment. Operation 316 proceeds to operation 318, according to one embodiment.

At operation 318, the decision engine 214 applies the user experience analytics model to the user characteristics data and to marketing experience options 234, according to one embodiment. The decision engine 214 applies the user experience analytics model to the user characteristics data and to the marketing experience options 234 to determine the distribution frequency rates for which a particular marketing experience option is to be distributed to users having one or more of the user characteristics received during operation 316, according to one embodiment. Operation 318 proceeds to operation 322, according to one embodiment.

At operation 322, the decision engine 214 selects a marketing experience option, according to one embodiment. The decision engine 214 selects a marketing experience option based on the distribution frequency rates generated by the user experience analytics model in response to receipt of user characteristics data that describe a user. The decision engine 214 generates a pseudo-random number that is weighted according to the distribution frequency rates generated by the user experience analytics model, according to one embodiment. For example, if the user experience analytics model generates distribution frequency rates of 0.8 for filling a user experience display with a background color of red and 0.2 for filling a user experience display with a background color of blue, then the decision engine 214 generates a binary number which will indicate selecting a blue background color 8 out of 10 times and will indicate selecting a red background color 2 out of 10 times, on average, according to one embodiment. Because computing systems typically generate “random” numbers using algorithms and clocks, a “random” number generated by a computing system is herein referred to as a “pseudo-random” number.

After the decision engine 214 selects a marketing experience option, the selected marketing experience option is provided to a user through one or more applications (e.g., a third party webpage, an email service, a customer support webpage, etc.), according to one embodiment.

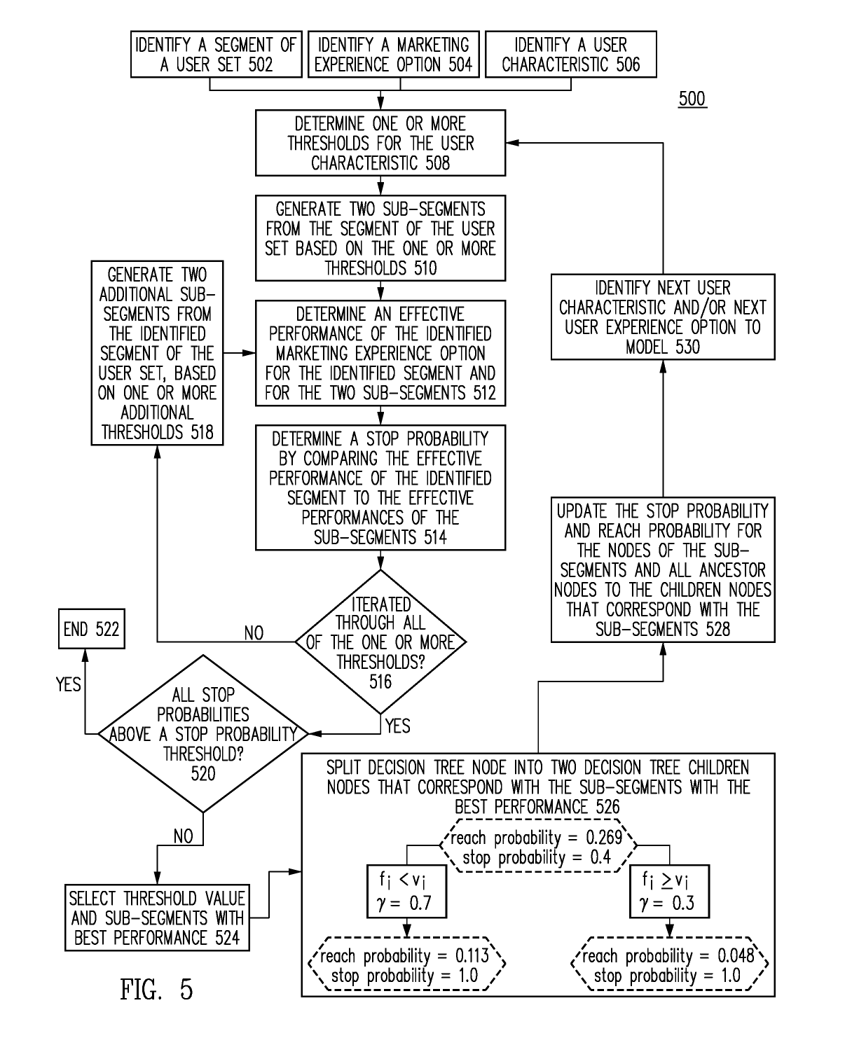

FIG. 5 illustrates an example of a process 500 that is employed or executed by the software system 211 of the production environment 200, to periodically update the user experience analytics model 219, according to one embodiment. By periodically updating the user experience analytics model and/or by defining/initializing the user experience analytics model 219, a software system (e.g., a tax return preparation system or other finance management system) can reap the benefits of deploying user experience options that are immediately effective on users (with a probabilistic certainty) while concurrently and adaptively testing user responses to other stimuli, e.g., other user experience options, to improve user satisfaction with the personalized user experience provided by the software system 211, according to one embodiment.

At operation 502 the process identifies a segment of a user set, according to one embodiment. The segment may be the entirety of the user set, may include recent users of the user set, may include users who have interacted with a software system over a predetermined period of time (e.g., during a previous year), or may be any other subset of the user set, according to one embodiment. Operation 502 proceeds to operation 508, according to one embodiment.

At operation 504, the process identifies a marketing experience option, according to one embodiment. The marketing experience option identified by the process is used by the process to define nodes, node properties, and edge logic for traversing from parent nodes to children nodes, according to one embodiment. In one embodiment, identifying a marketing experience option includes identifying a plurality of marketing experience options, according to one embodiment. In one embodiment, operation 504 occurs prior to operation 502, after operation 502, or concurrently with operation 502, according to one embodiment. Operation 504 proceeds to operation 508, according to one embodiment.

At operation 506, the process identifies a user characteristic, according to one embodiment. As described above, user characteristics can include personal identification information, income information, tax-related information, clickstream information, geographic location of the user, an IP address or other computing or other user computing device identification information, family information about the user, and the like, according to various embodiments. The process performs operation 506 before, in between, after, or concurrently with operation 502 and/or operation 504, according to one embodiment. Operation 506 proceeds to operation 508, according to one embodiment.

At operation 508, the process determines one or more thresholds for the user characteristic, according to one embodiment. By determining the one or more thresholds, the process is able to define additional segments of users, to determine if the identified marketing experience option more effectively causes one segment of users to perform a particular action better than another segment of users, according to one embodiment. In other words, a threshold value such as 35 years of age, for a user characteristic of age, can be used to bifurcate a segment of users of all ages into to a sub-segment of users who are less than 35 years old and a sub-segment of users who are at least 35 years old, according to one embodiment. Operation 508 proceeds to operation 510, according to one embodiment.

At operation 510, the process generates two sub-segments from the segment of the user set, based on the one or more thresholds, according to one embodiment. Operation 510 proceeds to operation 512, according to one embodiment.

At operation 512, the process determines an effective performance of the identified marketing experience option for the identified segment and for the two sub-segments, according to one embodiment. The effective performance of the marketing experience option for the identified segment and/or for the two sub-segments is a probabilistic distribution that users (who are defined by the segments and/or sub-segments) will perform one or more predetermined actions, according to one embodiment. Examples of the determined actions include, but are not limited to, answering questions, remaining logged into a user session of the software system, filing a tax return, progressing through a sequence of topics or a sequence of questions, clicking a button, reading an email, communicating with customer support personnel, interacting with a particular user experience object or element, paying for a service, selecting a user interface element in a webpage advertisement (e.g., an advertisement banner), submitting credit card information, providing an email address, providing a telephone number, and the like, according to various embodiments. In one embodiment, the process uses Thompson Sampling on user actions/responses from presented marketing experience options to determine a sample mean and a sample variance for the performance of marketing experience options on a segment of users, according to one embodiment. In one embodiment, the process uses Thompson Sampling blending or other mathematical techniques for calculating an average of multiple Thompson Samples to determine an effective performance of a marketing experience option on a segment or sub-segment, according to one embodiment. Operation 512 proceeds to operation 514, according to one embodiment.

At operation 514, the process determines a stop probability by comparing the effective performance of the identified segment to the effective performances of the two sub-segments of the identified segment, according to one embodiment. The stop probability is the probability that the performance of the identified segment is greater than the effective performance of the two sub-segments, according to one embodiment. In terms of nodes in a decision tree, the stop probability is the probability that the effective performance of a marketing experience option on a segment of users that is associated with a parent node is greater than an effective performance of marketing experience options on segments of users that are associated with children nodes, according to one embodiment. A low stop probability indicates that the likelihood of gaining additional effective performance from the user experience analytics model will likely be gained from splitting an identified segment into two sub-segments, according to one embodiment. Operation 514 proceeds to operation 516, according to one embodiment.

At operation 516, the process determines if the process has iterated through all identified thresholds for a user characteristic, according to one embodiment. For user characteristics having binary or Boolean outcomes such as yes or no, there may not be multiple thresholds to iterate through. However, if the user characteristics that are used to define part of the model have continuous values, e.g., users' ages, user income, and the like, then the process advantageously identifies and recurses through the multiple thresholds (e.g., through multiple age ranges or income ranges) to test the effective performance of a marketing experience option against variations of sub-segments, according to one embodiment. If the process completes iterating through all of the one or more thresholds, operation 516 proceeds to operation 520, according to one embodiment. If the process has not iterated through all of the one or more thresholds, operation 516 proceeds to operation 518, according to one embodiment.

At operation 518, the process generates two additional sub-segments from the identified segment of the user set, based on one or more additional thresholds, according to one embodiment. Operation 518 proceeds to operation 512, according to one embodiment.

At operation 520, the process determines if all stop probabilities are above a stop probability threshold, according to one embodiment. If all stop probabilities are above a stop probability threshold, e.g., 0.8, the operation 520 proceeds to operation 522 to end the process, according to one embodiment. If at least one of the stop probabilities is not above the stop probability threshold, operation 520 proceeds to operation 524.

At operation 524, the process selects a threshold value and the sub-segments with the best performance, according to one embodiment. The effective performance of segments and sub-segments is a probabilistic distribution having a sample mean and a sample variance. In one embodiment, the best performance includes a combination of a threshold and a marketing experience option that results in the highest sample mean. In one embodiment, the best performance includes a combination of a threshold and a marketing experience option that produces the lowest sample variance. In one embodiment, the best performance includes a combination of a threshold and a marketing experience option that produces the highest sample mean and/or the lowest sample variance while having a sample mean that is greater than a minimum threshold and/or while having a sample variance that is below a maximum sample variance threshold. Operation 524 proceeds to operation 526, according to one embodiment.

At operation 526, the process splits a decision tree node into two decision tree children nodes that correspond with the sub-segments with the best performance, according to one embodiment. When creating children nodes, the node properties (e.g., the reach probabilities, stop probabilities, marketing experience options, user characteristics for a segment of users, etc.) are defined for the children nodes and the node properties for the parent node of the split are updated. Operation 526 proceeds to operation 528, according to one embodiment.

At operation 528, the process updates the stop probability and the reach probability for the nodes of the sub-segments and all ancestor nodes to the children nodes that correspond with the sub-segments, according to one embodiment. For example, because the sum of the reach probabilities for the nodes of the decision tree is 1, the reach probabilities of ancestor nodes are updated to reflect the addition of the children node reach probabilities, according to one embodiment. Operation 528 proceeds to operation 530, according to one embodiment.

At operation 530, the process identifies a next user characteristic and/or a next marketing experience option to model, according to one embodiment. Operation 530 proceeds to operation 508, according to one embodiment.

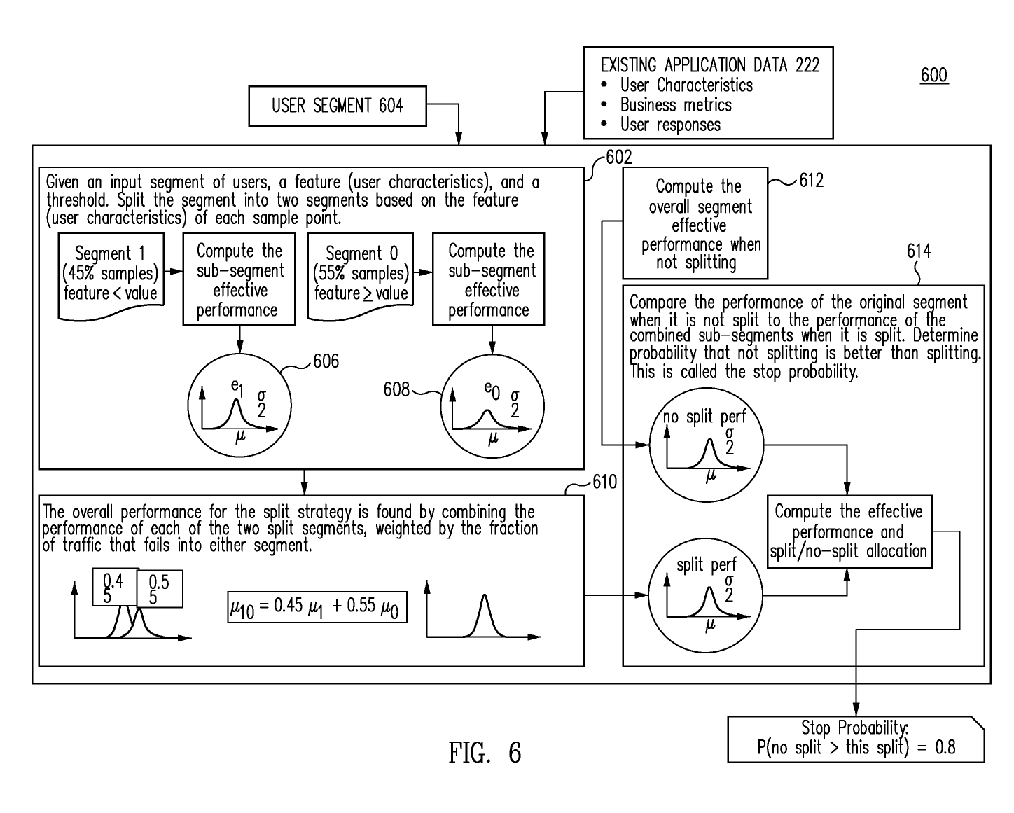

FIG. 6 illustrates an example of a flow diagram for a process 600 for determining a stop probability, according to one embodiment. The process 600 is an example of one technique for determining a stop probability that can be performed during operation 514 of FIG. 5 of the process 500 for defining a user experience analytics model, according to one embodiment.

At block 602, the process splits a user segment 604 into two sub-segments, and determines the effective performance of each sub-segment based on existing software system data 222, according to one embodiment. The existing software system data includes, but is not limited to, user characteristics data, user responses, conversion rates of users to paying customers, revenue generated by the software system, and the like, according to one embodiment. The sub-segments are split based on a value of the threshold and based on whether a user characteristic is less than the value or greater than or equal to the value of the threshold, according to one embodiment. The result of determining the effective performance of each sub-segment is a probabilistic distribution 606 and a probabilistic distribution 608 for the sub-segments, according to one embodiment. The probabilistic distributions 606 and 608 are not just an estimate of the performance of a marketing experience option on each sub-segment, instead, the probabilistic distributions 606 and 608 are estimations of the probability of the performance of a marketing experience option on the sub-segments. The effective performances result in probabilistic distributions because the effective performances are estimates of performance that include the uncertainty around how a user will respond to a marketing experience option integrated into the user's personalized marketing experience, according to one embodiment. The process proceeds from block 602 to block 610, according to one embodiment.

At block 610, the process determines/computes the combined effective performance of the effective performance of the two sub-segments, according to one embodiment. The process determines the combined effective performance by using addition or other mathematical operations to combine the performance of each sub-segment, with each sub-segment effective performance weighted by the edge frequency (γ) (fraction of parent node traffic from FIG. 4), to remove bias, in one embodiment. The process proceeds from block 610 to block 614, according to one embodiment.

At block 612, the process determines/computes the effective performance of the segment as though the sub-segments were not being split from the segment, according to one embodiment. In other words, the process computes the overall segment effective performance assuming the segment is not being split. The process proceeds from block 612 to block 614, according to one embodiment.

At block 614, the process compares the effective performance of the segment, when it is not split, to the combined effective performance of the sub-sections, to determine the stop probability, according to one embodiment. The stop probability is the probability that the effective performance of the un-split segment is greater or better than the effective performance of splitting the segment, according to one embodiment.

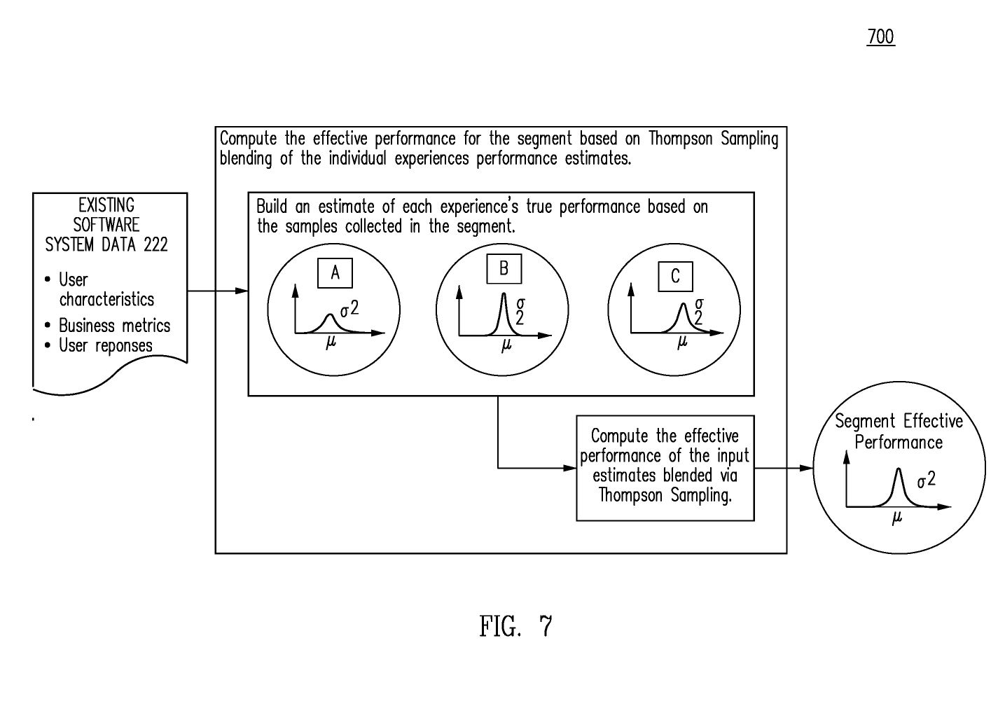

FIG. 7 illustrates an example of a flow diagram of a process 700 for computing the effective performance of a segment or sub-segment of users, according to one embodiment. The process 700 is an example of one technique that can be used by operation 512 (shown in FIG. 5) for the process 500 for defining a user experience analytics model, according to one embodiment. The process 700 is an example of one technique that can be used in blocks 602 and/or 612 (shown in FIG. 6) for the process 600 for determining a stop probability, according to one embodiment.

The process 700 uses existing software system data 222 to compute the effective performance for a segment based on Thompson Sampling blending of the performance of individual marketing experience options and/or based on each individual user's experience/feedback with the software system (e.g., in response to receiving the marketing experience option in the user's personalized marketing experience), according to one embodiment.

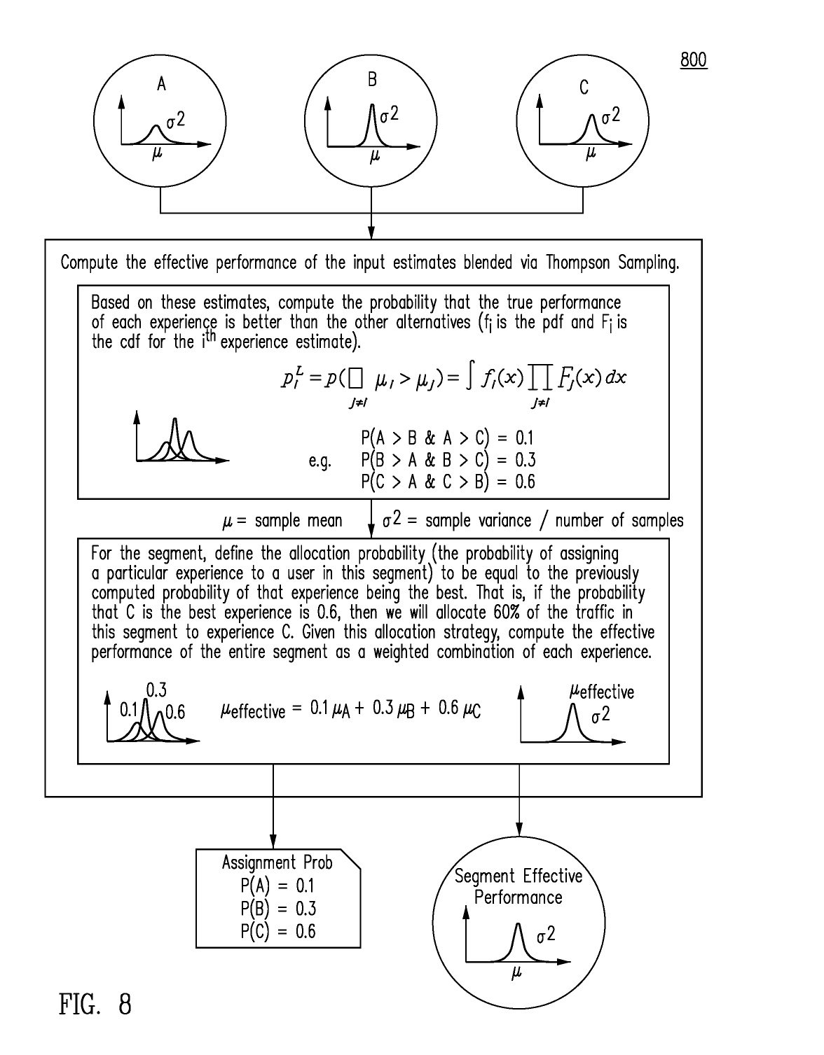

FIG. 8 illustrates an example flow diagram for a process 800 for computing the effective performance of input estimates blended by Thompson Sampling, according to one embodiment. The process 800 is an example of one technique that can be used in block 614 (show in FIG. 6) of the process 600 for determining a stop probability, according to one embodiment. The process 800 is an example of one technique that can be used during the process 700 for computing the effective performance of a segment or sub-segment, according to one embodiment.

The process 800 uses the probability density function (“PDF”) and the cumulative distribution function (“CDF”) to determine the probability that the true performance of each user's experience or of each marketing experience option is better than alternative options, according to one embodiment. As illustrated in FIG. 8, the process 800 computes the effective performance of an entire segment of users as a weighted combination of either each user's experience or of the distribution of a particular marketing experience option to the users of the segment of users, in one embodiment.

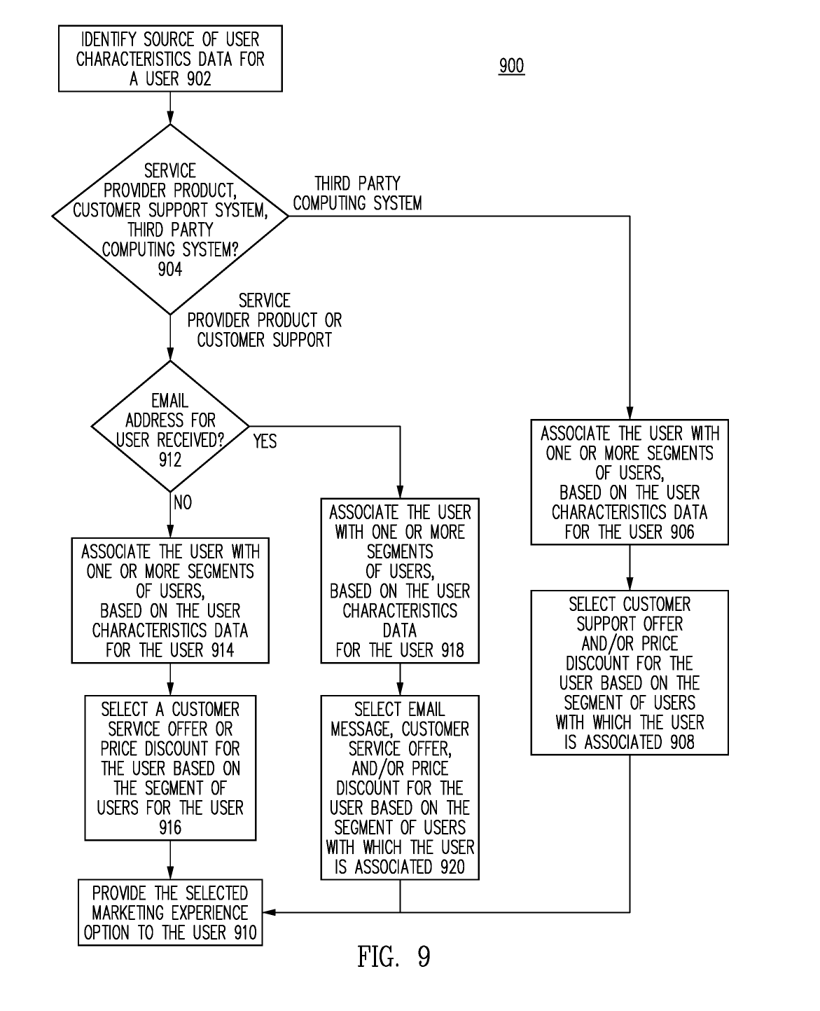

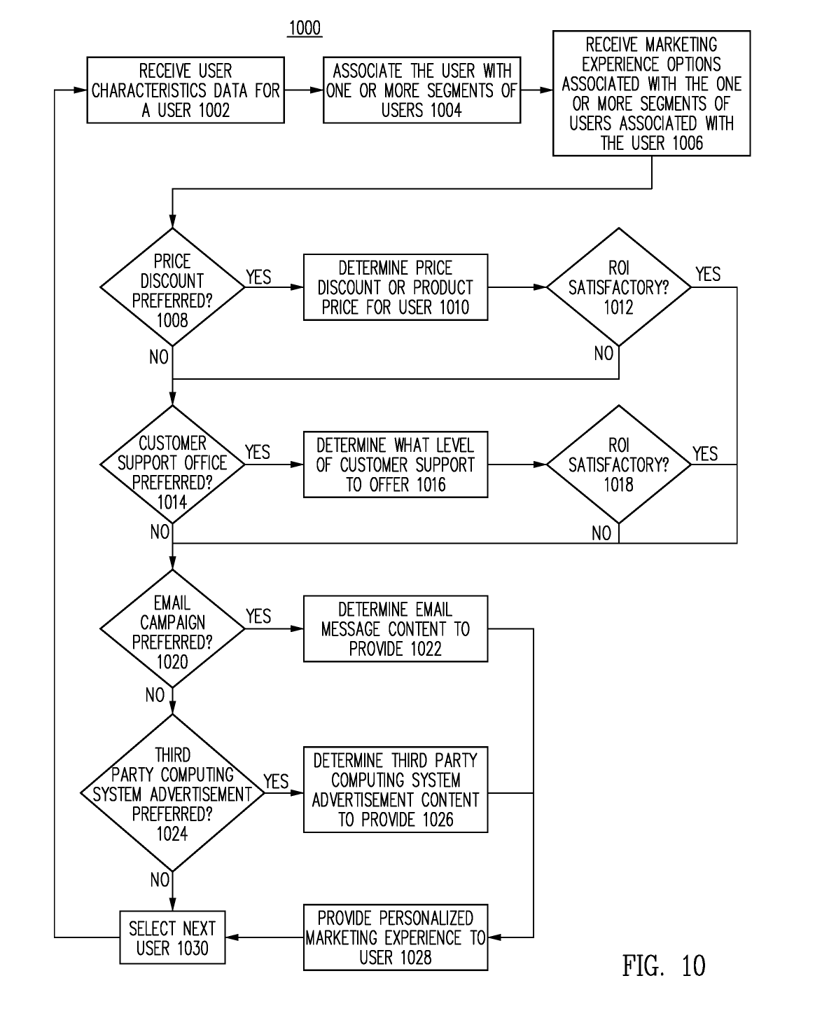

FIG. 9 illustrates an example flow diagram of a process 900 for providing personalized marketing experiences to users from a software system, according to one embodiment. In one embodiment, the software system that generates the personalized marketing experiences for user determines which marketing experience to provide based on the source of the user's user characteristics data received by the software system.

At operation 902, the process identifies a source of user characteristics data for a user, according to one embodiment. Sources of user characteristics data for user include, but are not limited to, service provider products (e.g., a tax return preparation system, a financial management system, etc.), a customer support system, and third party computing system, according to one embodiment. Third party computing systems include, but are not limited to, search engine providers, web site providers/host, government entities, public record systems, and the like, according to one embodiment. Operation 902 proceeds to operation 904, according to one embodiment.

At operation 904, the process determines if the source of the user characteristics data is a service provider product, a customer support system, or a third-party system, according to one embodiment. If the process determines that the source of the user characteristics data for a user is a third party computing system, operation 904 proceeds to operation 906, according to one embodiment. If the process determines that the source of the user characteristics data for a user is a service provider product or a customer support system, the operation 904 proceeds to operation 912, according to one embodiment.

At operation 906, the process associates the user with one or more segments of users, based on the user characteristics data for the user, according to one embodiment. The process applies the user characteristics data for the user to a user experience analytics model (e.g., using a decision tree) to determine which one or more segments of users the user's user characteristics data correlates with, to associate the user with other users who are likely to have marketing preferences that are similar to the marketing preferences of the user, according to one embodiment. Operation 906 proceeds to operation 908, according to one embodiment.

At operation 908, the process selects a customer support offer and/or a price discount for the user, based on the segment of users with which the user is associated, according to one embodiment. For example, the segment of users with which the user has been associated they have a preference for receiving particular customer support offers more than receiving a discount price, so selecting a marketing experience option that is preferable to the user increases the likelihood that the user will complete a particular action, such as file a tax return or purchasing a service, according to one embodiment. Operation 908 proceeds to operation 910, according to one embodiment.

At operation 910, the process provides the selected marketing experience option to the user, according to one embodiment. If the source of the user characteristics data for user is from a third party computing system, such as a search engine, the process may provide the selected marketing experience option to the user through an advertisement, such as a banner, picture, hyperlinks, or other advertisement displayed as part of a search engine result, according to one embodiment.

At operation 912, the process determines if an email address for the user has been received, according to one embodiment. If a user begins use of a service provider product (e.g., a tax return preparation system), the user typically provides the user's email address. Similarly, if the user contacts a customer support service, the user typically provides an email address. If the user does not provide an email address, the software system can provide personalized marketing experiences to the user through the service provider product or customer support service that the user is interacting with, based on the user characteristics data acquired from/about the user during the user's interaction with the service provider product or customer support service, according to one embodiment. If the user provides an email address, and self or system can provide personalized marketing experiences to the user through an email campaign, e.g., by transmitting one or more marketing email messages at a later time, according to one embodiment. If the user does not provide an email address, operation 912 proceeds to operation 914, according to one embodiment. If the user provides an email address, operation 912 proceeds to operation 918, according to one embodiment.

At operation 914, the process associates the user with one or more segments of users, based on the user characteristics data for the user, according to one embodiment. Operation 914 proceeds to operation 916, according to one embodiment.

At operation 916, the process selects a customer support offer or price discount for the user, based on the segment of users with which the user is associated, according to one embodiment. The customer support offer and/or the price discount can be displayed through a pop-up window, and a text box within a webpage, through an audio recording, through a video/multimedia message, or the like, according to one embodiment. Operation 916 proceeds to operation 910, according to one embodiment.

At operation 918, the process associates the user with one or more segments of users, based on the user characteristics data for the user, according to one embodiment. Operation 918 proceeds to operation 920, according to one embodiment.

At operation 920, the process selects an email message, a customer support offer, and/or a price discount for the user based on the segment of users with which the user is associated, according to one embodiment. The selection of a particular type of marketing experience is based on the likelihood that the type of marketing experience is a preferred type of marketing experience for the user, according to one embodiment. An email message can have a number of features, characteristics, and/or content that is selected based on the likelihood that the features, characteristics, and/or content are preferred by the user, at least partially based on the user characteristics data for the user, and at least partially based on the one or more segments of users with which the user is associated, according to one embodiment. Operation 920 proceeds to operation 910, according to one embodiment.

In one embodiment, the software system that generates the personalized marketing experiences for user determines which marketing experience to provide based on the source of the user's user characteristics data received by the software system.

FIG. 10 illustrates an example flow diagram of a process 1000 for providing personalized marketing experiences to users from a software system, according to one embodiment. In one embodiment, the software system determines which marketing experiences to provide to a user based on which one or more marketing experience options are likely to be effective for the segment of users with which the user is associated.

At operation 1002, the process receives user characteristics data for user, according to one embodiment.

At operation 1004, the process associates the user with one or more segments of users, according to one embodiment. The process associates user with one or more segments of users, was partially based on the user characteristics data for the user, according to one embodiment.

At operation 1006, the process receives marketing experience options associated with the one or more segments of users that are associated with the user, according to one embodiment. The marketing experience options include, but are not limited to, email messages, product price discounts, customer support offers, and web-based advertisements through third party computing system/services, according to one embodiment. Operation 1006 proceeds to operation 1008, according to one embodiment.

At operation 1008, the process determines if a price discount is likely to be preferred by the user, according to one embodiment. The process determines if a price discount is likely to be preferred by the user by applying the user's characteristics data to a user experience analytics model to determine if other users who are similar to the user prefer price discounts, according to one embodiment. If a price discount is likely to be preferred by the user, the process selects this particular marketing experience options for delivery to the user, and operation 1008 proceeds to operation 1010, according to one embodiment. If the price discount is not likely to be preferred by the user, operation 1008 proceeds to operation 1014, according to one embodiment.

At operation 1010, the process determines a price discount or product price for the user, according to one embodiment. The process determines a price discount or product price for the user, based on the segment of users associated with the user, according to one embodiment. Operation 1010 proceeds to operation 1012, according to one embodiment.

At operation 1012, the process determines if the return on investment (“ROI”) is satisfactory, according to one embodiment. A satisfactory ROI is based at least partially on the amount of the determined discount, the quantity of revenue that the service provider is likely to receive from the user, and the like, according to one embodiment. If the ROI is not satisfactory, operation 1012 proceeds to operation 1014, according to one embodiment. If the ROI is satisfactory, the process selects the marketing experience option for delivery to the user and operation 1012 proceeds to operation 1020, according to one embodiment.

At operation 1014, the process determines if a customer support offer is likely to be preferred by the user, according to one embodiment. The process determines if a customer support offer is likely to be determined by the user by applying the user's characteristics data to a user experience analytics model to determine if other users who are similar to the user prefer customer support offers, according to one embodiment. If a customer support offer is likely to be preferred by the user, operation 1014 proceeds to operation 1016, according to one embodiment. If a customer support offer is not likely to be preferred by the user, operation 1014 proceeds to operation 1020, according to one embodiment.

At operation 1016, the process determines a level of customer support to offer the user, according to one embodiment. Levels of customer support include, but are not limited to, free or discounted communication with a certified public accountant, free or discounted communication with a tax return specialist, reference to self-help guides, other free or discounted communication with customer support personnel, and a like, according to one embodiment. Operation 1016 proceeds to operation 1018, according to one embodiment.

At operation 1018, the process determines if the ROI is satisfactory, according to one embodiment. Satisfactory ROI is based at least partially on the level of customer support selected for the user, the cost of the level of customer support selected for the user, and the estimated revenue that the service provider is likely received from the user, according to one embodiment. If the process determines that the ROI is not satisfactory, operation 1018 proceeds to operation 1020, according to one embodiment. If the process determines that the ROI is satisfactory, the process selects the marketing experience option for delivery to the user and operation 1018 proceeds to operation 1020, according to one embodiment.

At operation 1020, the process determines if an email campaign is likely to be preferred by the user, according to one embodiment. The process determines if an email campaign is likely to be preferred by the user by applying the user's characteristics data to a user experience analytics model to determine if other users who are similar to the user prefer email campaigns, according to one embodiment. If an email campaign/message is likely to be preferred by the user, operation 1020 proceeds to operation 1022, according to one embodiment. If an email campaign first message is not likely to be preferred by the user, operation 1020 proceeds to operation 1024, according to one embodiment.

At operation 1022, the process determines email message content to provide to the user, according to one embodiment. If the process selected a price discount and/or a customer support offer, the process determines which (if not both) marketing experience options to include in an email message to the user, according to one embodiment. If an email campaign/message is preferred by the user, the process determines other formatting, features, characteristics, etc. of the email campaign to provide to the user, at least partially based on the one or more segments of users associated with the user, and at least partially based on the user's characteristics data, according to one embodiment. Operation 1022 proceeds to operation 1028, according to one embodiment.

At operation 1028, the process provides personalized marketing experience to the user, according to one embodiment. Operation 1028 proceeds to operation 1030, according to one embodiment.

At operation 1030, the process selects a next user, according to one embodiment. Operation 1030 proceeds to operation 1002, according to one embodiment.

At operation 1024, the process determines if a third party advertisement is likely to be preferred by the user, according to one embodiment. The process determines if a third party advertisement is likely to be preferred by the user by applying the user's characteristics data to a user experience analytics model to determine if other users who are similar to the user prefer third party advertisements, according to one embodiment. If a third party advertisement is not likely to be preferred by the user, operation 1024 proceeds to operation 1030, according to one embodiment. If a third party advertisement is likely to be preferred by the user, operation 1024 proceeds to operation 1026, according to one embodiment.

At operation 1026, the process determines third party computing system advertisement content to provide to the user, according to one embodiment. If the process selected a price discount and/or a customer support offer, the process determines which (if not both) marketing experience options to include in a third party computing system advertisement displayed for the user, according to one embodiment. If a third party computing system advertisement is preferred by the user, the process determines other formatting, features, characteristics, etc. of the third party computing system advertisement to provide to the user, at least partially based on the one or more segments of users associated with the user, and at least partially based on the user's characteristics data, according to one embodiment. Operation 1026 proceeds to operation 1028, according to one embodiment.

In one embodiment, a software system determines which marketing experiences to provide to a user based on which one or more marketing experience options are likely to be effective for the segment of users with which the user is associated.

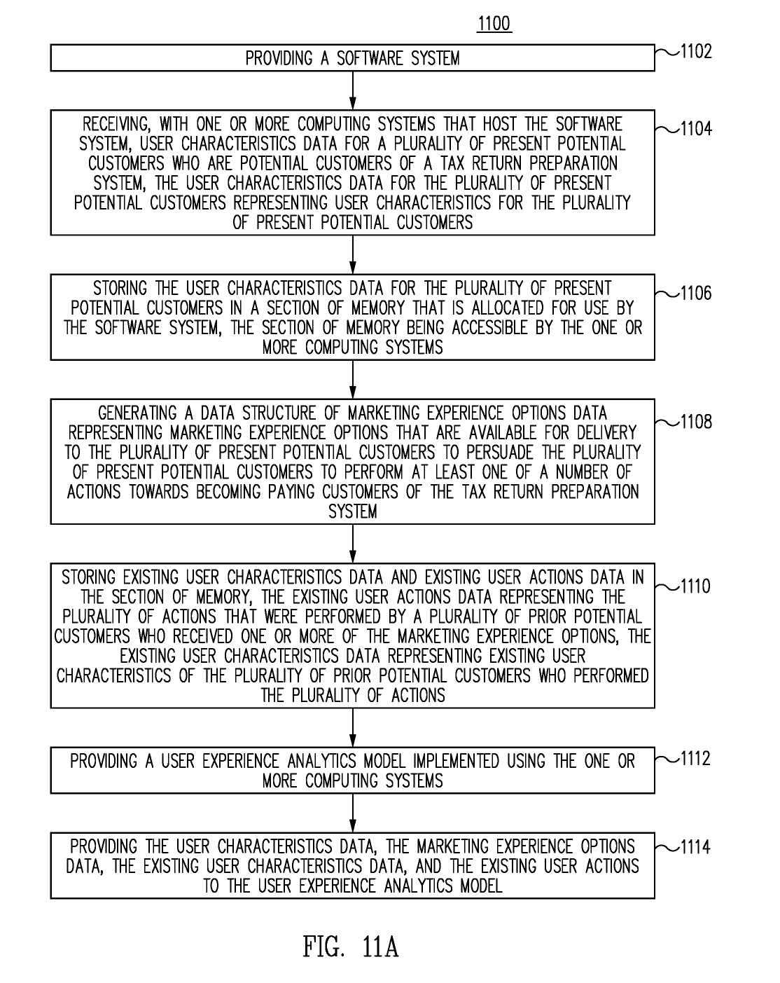

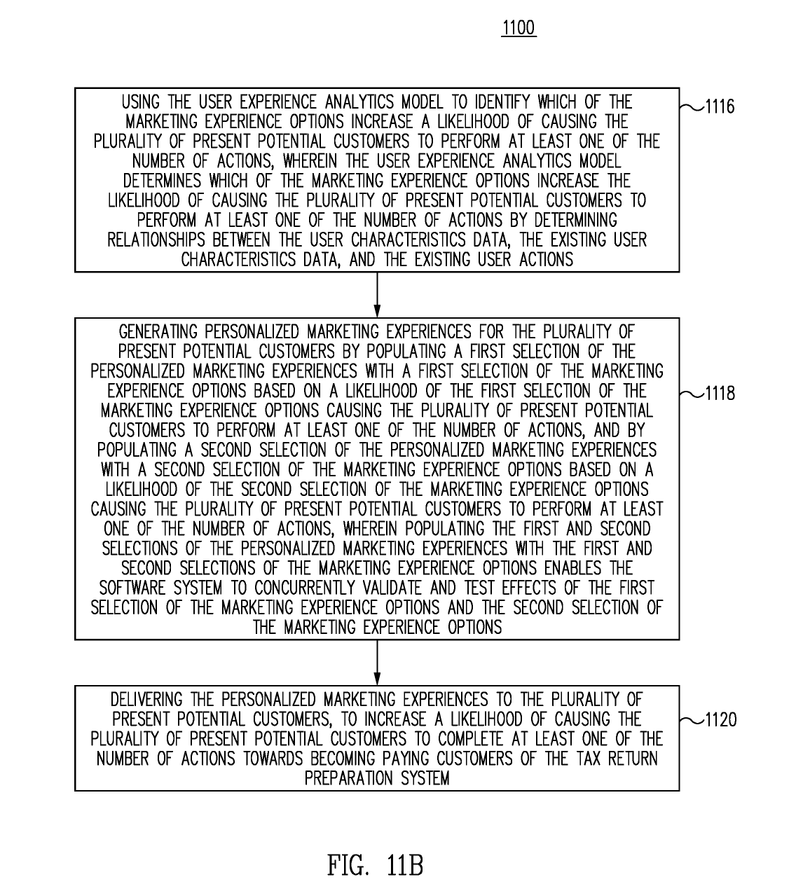

FIGS. 11A and 11B illustrate an example flow diagram of a process 1100 for providing personalized marketing experiences to users from a software system, according to one embodiment.

At operation 1102, the process includes providing a software system, according to one embodiment.

At operation 1104, the process includes receiving, with one or more computing systems that host the software system, user characteristics data for a plurality of present potential customers who are potential customers of a tax return preparation system, the user characteristics data for the plurality of present potential customers representing user characteristics for the plurality of present potential customers, according to one embodiment.

At operation 1106, the process includes storing the user characteristics data for the plurality of present potential customers in a section of memory that is allocated for use by the software system, the section of memory being accessible by the one or more computing systems, according to one embodiment.

At operation 1108, the process includes generating a data structure of marketing experience options data representing marketing experience options that are available for delivery to the plurality of present potential customers to persuade the plurality of present potential customers to perform at least one of a number of actions towards becoming paying customers of the tax return preparation system, according to one embodiment.

At operation 1110, the process includes storing existing user characteristics data and existing user actions data in the section of memory, the existing user actions data representing the plurality of actions that were performed by a plurality of prior potential customers who received one or more of the marketing experience options, the existing user characteristics data representing existing user characteristics of the plurality of prior potential customers who performed the plurality of actions, according to one embodiment.

At operation 1112, the process includes providing a user experience analytics model implemented using the one or more computing systems, according to one embodiment.

At operation 1114, the process includes providing the user characteristics data, the marketing experience options data, the existing user characteristics data, and the existing user actions to the user experience analytics model, according to one embodiment.

At operation 1116, the process includes using the user experience analytics model to identify which of the marketing experience options increase a likelihood of causing the plurality of present potential customers to perform at least one of the number of actions, wherein the user experience analytics model determines which of the marketing experience options increase the likelihood of causing the plurality of present potential customers to perform at least one of the number of actions by determining relationships between the user characteristics data, the existing user characteristics data, and the existing user actions, according to one embodiment.

At operation 1118, the process includes generating personalized marketing experiences for the plurality of present potential customers by populating a first selection of the personalized marketing experiences with a first selection of the marketing experience options based on a likelihood of the first selection of the marketing experience options causing the plurality of present potential customers to perform at least one of the number of actions, and by populating a second selection of the personalized marketing experiences with a second selection of the marketing experience options based on a likelihood of the second selection of the marketing experience options causing the plurality of present potential customers to perform at least one of the number of actions, wherein populating the first and second selections of the personalized marketing experiences with the first and second selections of the marketing experience options enables the software system to concurrently validate and test effects of the first selection of the marketing experience options and the second selection of the marketing experience options, according to one embodiment.

At operation 1120, the process includes delivering the personalized marketing experiences to the plurality of present potential customers, to increase a likelihood of causing the plurality of present potential customers to complete at least one of the number of actions towards becoming paying customers of the tax return preparation system, according to one embodiment.

Embodiments of the present disclosure address some of the shortcomings associated with traditional tax return preparation systems and other software systems by providing personalized user experiences in a software system, to provide personalized user experience options to some users while concurrently testing the user responses of other users to other user experience options, according to one embodiment. The disclosed software system selects the user experience options by applying user characteristics data to a user experience analytics model, according to one embodiment. The software system analyzes user responses to the user experience options to update the analytics model and to adapt the personalization of the user experience options at least partially based on feedback from users, according to one embodiment.

By providing personalized marketing experiences in software systems for software products, such as tax return preparation systems, implementation of embodiments of the present disclosure allows for significant improvement to the fields of electronic marketing, customer service, user experience, electronic tax return preparation, data collection, and data processing, according to one embodiment. As one illustrative example, by adaptively distributing marketing experiences to users based on the users' characteristics and based on distributive frequency rates (described below), embodiments of the present disclosure allows for targeted marketing, targeting customer recruitment, and targeted customer retention with a software system for a tax return preparation system or other software product with fewer processing cycles and less communications bandwidth because the users preferences are efficiently and effectively determined based on their characteristics. Implementation of the disclosed techniques reduces processing cycles and communications bandwidth because marketing content is selectively sent to users who are likely to positively respond/act to the marketing content, as opposed to sending marketing content to all potential customers in the world or in a country. In other words, by personalizing marketing experiences, global energy consumption can be reduced by reducing less-effective efforts, communications, and communications systems. As a result, embodiments of the present disclosure allow for improved processor performance, more efficient use of memory access and data storage capabilities, reduced communication channel bandwidth utilization, and therefore faster communications connections.

In addition to improving overall computing performance, by dynamically and adaptively providing personalized marketing experiences in software systems, implementation of embodiments of the present disclosure represent a significant improvement to the field of automated user experiences and, in particular, efficient use of human and non-human resources. As one illustrative example, by increasing personal preferences for marketing experiences and by reducing presentation of non-preferred/less-effective marketing experiences, the user can more easily comprehend and interact with digital marketing experience displays and computing environments, reducing the overall time invested by the user to the tax return preparation or other software system-related tasks. Additionally, selectively presenting marketing experiences to users, based on their user characteristics, improves and/or increases the likelihood that a potential customer will be converted into a paying customer because the potential customer receives confirmation that the software system or service provider appears to understand the particular user's needs and preferences, according to one embodiment. Consequently, using embodiments of the present disclosure, the user-received marketing experience is less burdensome, less impersonal, and more persuasive to potential customers, former customers, and current customers receiving the marketing experiences.

In accordance with an embodiment, a computer system implemented method provides personalized marketing experiences to users, from a software system. The method includes, providing a software system, according to one embodiment. The method includes, receiving, with one or more computing systems that host the software system, user characteristics data for a plurality of present potential customers who are potential customers of a tax return preparation system, the user characteristics data for the plurality of present potential customers representing user characteristics for the plurality of present potential customers, according to one embodiment. The method includes, storing the user characteristics data for the plurality of present potential customers in a section of memory that is allocated for use by the software system, the section of memory being accessible by the one or more computing systems, according to one embodiment. The method includes, generating a data structure of marketing experience options data representing marketing experience options that are available for delivery to the plurality of present potential customers to persuade the plurality of present potential customers to perform at least one of a number of actions towards becoming paying customers of the tax return preparation system, according to one embodiment. The method includes, storing existing user characteristics data and existing user actions data in the section of memory, the existing user actions data representing the plurality of actions that were performed by a plurality of prior potential customers who received one or more of the marketing experience options, the existing user characteristics data representing existing user characteristics of the plurality of prior potential customers who performed the plurality of actions, according to one embodiment. The method includes, providing a user experience analytics model implemented using the one or more computing systems, according to one embodiment. The method includes, providing the user characteristics data, the marketing experience options data, the existing user characteristics data, and the existing user actions to the user experience analytics model, according to one embodiment. The method includes, using the user experience analytics model to identify which of the marketing experience options increase a likelihood of causing the plurality of present potential customers to perform at least one of the number of actions, according to one embodiment. The user experience analytics model determines which of the marketing experience options increase the likelihood of causing the plurality of present potential customers to perform at least one of the number of actions by determining relationships between the user characteristics data, the existing user characteristics data, and the existing user actions, according to one embodiment. The method includes, generating personalized marketing experiences for the plurality of present potential customers by populating a first selection of the personalized marketing experiences with a first selection of the marketing experience options based on a likelihood of the first selection of the marketing experience options causing the plurality of present potential customers to perform at least one of the number of actions, and by populating a second selection of the personalized marketing experiences with a second selection of the marketing experience options based on a likelihood of the second selection of the marketing experience options causing the plurality of present potential customers to perform at least one of the number of actions, according to one embodiment. Populating the first and second selections of the personalized marketing experiences with the first and second selections of the marketing experience options enables the software system to concurrently validate and test effects of the first selection of the marketing experience options and the second selection of the marketing experience options, according to one embodiment. The method includes, delivering the personalized marketing experiences to the plurality of present potential customers, to increase a likelihood of causing the plurality of present potential customers to complete at least one of the number of actions towards becoming paying customers of the tax return preparation system, according to one embodiment.

In accordance with an embodiment, a computer system implemented method provides personalized marketing experiences to users from a software system. The method includes providing a software system, according to one embodiment. The method includes, receiving, with one or more computing systems that host the software system, user characteristics data for a plurality of present potential customers who are potential customers of a tax return preparation system, the user characteristics data for the plurality of present potential customers representing user characteristics for the plurality of present potential customers, according to one embodiment. The method includes, storing the user characteristics data for the plurality of present potential customers in a section of memory that is allocated for use by the software system, the section of memory being accessible by the one or more computing systems, according to one embodiment. The method includes, generating a data structure of marketing experience options data representing marketing experience options that are available for delivery to the plurality of present potential customers to encourage the plurality of present potential customers to perform at least one of a plurality of actions towards becoming paying customers of the tax return preparation system, according to one embodiment. The method includes, storing existing user characteristics data and existing user actions data in the section of memory, the existing user actions data representing the plurality of actions that were performed by a plurality of prior potential customers who received one or more of the marketing experience options, the existing user characteristics data representing existing user characteristics of the plurality of prior potential customers who performed the plurality of actions, according to one embodiment. The method includes, training a user experience analytics model to identify preferences of the plurality of present potential customers for the marketing experience options, wherein training the user experience analytics model includes: defining segments of users that are sub-groups of the plurality of prior potential customers who commonly share one or more existing user characteristics; and determining levels of performance for the marketing experience options among the segments of users, wherein the levels of performance for the marketing experience options indicate likelihoods of the segments of users to perform one or more of the plurality of actions in response to receipt of one or more of the marketing experience options, according to one embodiment. The method includes, applying the user characteristics data to the user experience analytics model to associate each of the plurality of present potential customers with at least one of the segments of users, based on similarities between the user characteristics data and the existing user characteristics data, according to one embodiment. The method includes, delivering at least two of the marketing experiences options to at least two subsets of each of the segments of users, to provide at least two different personalized marketing experiences to the plurality of present potential customers of each of the segments of users, according to one embodiment. The method includes, updating the user experience analytics model, at least partially based on ones of the plurality of actions performed by the plurality of present potential customers of each of the segments of users in response to receiving the plurality of marketing experience options, to identify a more effective one of the at least two different marketing experiences to increase the likelihoods of the segments of users to perform the plurality of user actions, according to one embodiment.

In accordance with an embodiment, a non-transitory computer-readable medium, has instructions which, when executed by one or more processors, performs a method for providing personalized marketing experiences to users. The method includes providing a software system, according to one embodiment. The method includes, receiving, with one or more computing systems that host the software system, user characteristics data for a plurality of present potential customers who are potential customers of a tax return preparation system, the user characteristics data for the plurality of present potential customers representing user characteristics for the plurality of present potential customers, according to one embodiment. The method includes, storing the user characteristics data for the plurality of present potential customers in a section of memory that is allocated for use by the software system, the section of memory being accessible by the one or more computing systems, according to one embodiment. The method includes, generating a data structure of marketing experience options data representing marketing experience options that are available for delivery to the plurality of present potential customers to persuade the plurality of present potential customers to perform at least one of a number of actions towards becoming paying customers of the tax return preparation system, according to one embodiment. The method includes, storing existing user characteristics data and existing user actions data in the section of memory, the existing user actions data representing the plurality of actions that were performed by a plurality of prior potential customers who received one or more of the marketing experience options, the existing user characteristics data representing existing user characteristics of the plurality of prior potential customers who performed the plurality of actions, according to one embodiment. The method includes, providing a user experience analytics model implemented using the one or more computing systems, according to one embodiment. The method includes, providing the user characteristics data, the marketing experience options data, the existing user characteristics data, and the existing user actions to the user experience analytics model, according to one embodiment. The method includes, using the user experience analytics model to identify which of the marketing experience options increase a likelihood of causing the plurality of present potential customers to perform at least one of the number of actions, according to one embodiment. The user experience analytics model determines which of the marketing experience options increase the likelihood of causing the plurality of present potential customers to perform at least one of the number of actions by determining relationships between the user characteristics data, the existing user characteristics data, and the existing user actions, according to one embodiment. The method includes, generating personalized marketing experiences for the plurality of present potential customers by populating a first selection of the personalized marketing experiences with a first selection of the marketing experience options based on a likelihood of the first selection of the marketing experience options causing the plurality of present potential customers to perform at least one of the number of actions, and by populating a second selection of the personalized marketing experiences with a second selection of the marketing experience options based on a likelihood of the second selection of the marketing experience options causing the plurality of present potential customers to perform at least one of the number of actions, according to one embodiment. Populating the first and second selections of the personalized marketing experiences with the first and second selections of the marketing experience options enables the software system to concurrently validate and test effects of the first selection of the marketing experience options and the second selection of the marketing experience options, according to one embodiment. The method includes, delivering the personalized marketing experiences to the plurality of present potential customers, to increase a likelihood of causing the plurality of present potential customers to complete at least one of the number of actions towards becoming paying customers of the tax return preparation system, according to one embodiment.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating,” “accessing,” “adding,” “aggregating,” “alerting,” “applying,” “analyzing,” “associating,” “calculating,” “capturing,” “categorizing,” “classifying,” “comparing,” “creating,” “defining,” “detecting,” “determining,” “distributing,” “eliminating,” “encrypting,” “extracting,” “filtering,” “forwarding,” “generating,” “identifying,” “implementing,” “informing,” “monitoring,” “obtaining,” “posting,” “processing,” “providing,” “receiving,” “requesting,” “saving,” “sending,” “storing,” “substituting,” “transferring,” “transforming,” “transmitting,” “using,” etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computer system implemented method for providing personalized marketing experiences to users, from a software system, comprising:
providing a software system;
receiving, with one or more computing systems that host the software system, user characteristics data for a plurality of present potential customers who are potential customers of a tax return preparation system, the user characteristics data for the plurality of present potential customers representing user characteristics for the plurality of present potential customers;
storing the user characteristics data for the plurality of present potential customers in a section of memory that is allocated for use by the software system, the section of memory being accessible by the one or more computing systems;
generating a data structure of marketing experience options data representing marketing experience options that are available for delivery to the plurality of present potential customers to persuade the plurality of present potential customers to perform at least one of a number of actions towards becoming paying customers of the tax return preparation system;
storing existing user characteristics data and existing user actions data in the section of memory, the existing user actions data representing the number of actions that were performed by a plurality of prior potential customers who received one or more of the marketing experience options, the existing user characteristics data representing existing user characteristics of the plurality of prior potential customers who performed the number of actions;
providing a user experience analytics model implemented using the one or more computing systems;
providing the user characteristics data, the marketing experience options data, the existing user characteristics data, and the existing user actions to the user experience analytics model;
using the user experience analytics model to identify which of the marketing experience options increase a likelihood of causing the plurality of present potential customers to perform at least one of the number of actions,
wherein the user experience analytics model determines which of the marketing experience options increase the likelihood of causing the plurality of present potential customers to perform at least one of the number of actions by determining relationships between the user characteristics data, the existing user characteristics data, and the existing user actions; and
generating personalized marketing experiences for the plurality of present potential customers by populating a first selection of the personalized marketing experiences with a first selection of the marketing experience options based on a likelihood of the first selection of the marketing experience options causing the plurality of present potential customers to perform at least one of the number of actions, and by populating a second selection of the personalized marketing experiences with a second selection of the marketing experience options based on a likelihood of the second selection of the marketing experience options causing the plurality of present potential customers to perform at least one of the number of actions,
wherein populating the first and second selections of the personalized marketing experiences with the first and second selections of the marketing experience options enables the software system to concurrently validate and test effects of the first selection of the marketing experience options and the second selection of the marketing experience options; and
delivering the personalized marketing experiences to the plurality of present potential customers, to increase a likelihood of causing the plurality of present potential customers to complete at least one of the number of actions towards becoming paying customers of the tax return preparation system.

2. The computer system implemented method of claim 1, wherein the marketing experience options are selected from a group of marketing experience options consisting of:
an email campaign of email messages;
a customer support offer of one or more customer support services;
a price discount off of a price of one or more services provided by a service provider; and
advertisements displayed with a third party computing environment.

3. The computer system implemented method of claim 2, wherein the third party computing environment is a search engine computing environment or a web site provider computing environment.

4. The computer system implemented method of claim 1, wherein the user experience analytics model includes a hierarchical decision tree, the hierarchical decision tree having a plurality of nodes, each node being associated with one of a plurality of segments of users and being associated with distribution frequency rates for applying one or more of the marketing experience options to the plurality of segments of users.

5. The computer system implemented method of claim 4, wherein the distribution frequency rates are probabilities with which at least two different ones of the marketing experience options are provided to at least two subsets of the plurality of present potential customers who are in a same one of the plurality of segments of users.

6. The computer system implemented method of claim 1, wherein populating the marketing experiences for the plurality of present potential customers based on the likelihood of the first selection and based on the likelihood of the second selection is an implementation of dynamic A/B testing of the marketing experience options.

7. The computer system implemented method of claim 1, wherein the user characteristics data and the existing user characteristics data are selected from a group of user characteristics data consisting of:
data indicating user computing system characteristics;
data indicating time-related information;
data indicating geographical information;
data indicating external and independent marketing segments;
data identifying an external referrer of the user;
data indicating a number of visits made to a service provider website;
data indicating an age of the user;
data indicating an age of a spouse of the user;
data indicating a zip code;
data indicating a tax return filing status;
data indicating state income;
data indicating a home ownership status;
data indicating a home rental status;
data indicating a retirement status;
data indicating a student status;
data indicating an occupation of the user;
data indicating an occupation of a spouse of the user;
data indicating whether the user is claimed as a dependent;
data indicating whether a spouse of the user is claimed as a dependent;
data indicating whether another taxpayer is capable of claiming the user as a dependent;
data indicating whether a spouse of the user is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user filed a previous years' federal itemized deduction;
data indicating whether the user filed a previous years' state itemized deduction;
data indicating whether the user is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.

8. The computer system implemented method of claim 1, wherein the number of actions are selected from a group of number actions consisting of:
reading email message content;
selecting a hyperlink from an email message;
visiting a particular web site;
selecting a hyperlink or advertisement from a webpage;
hovering a mouse over a hyperlink or advertisement within a webpage;
providing additional personal information to at least one of the tax return preparation system and the software system;
completing a sequence of questions;
purchasing a service;
filing a tax return with the tax return preparation system; and
using the tax return preparation system for at least a predetermined period of time.

9. The computer system implemented method of claim 1, wherein the tax return preparation system is part of the software system.

10. A computer system implemented method for providing personalized marketing experiences to users from a software system, comprising:
providing a software system;
receiving, with one or more computing systems that host the software system, user characteristics data for a plurality of present potential customers who are potential customers of a tax return preparation system, the user characteristics data for the plurality of present potential customers representing user characteristics for the plurality of present potential customers;
storing the user characteristics data for the plurality of present potential customers in a section of memory that is allocated for use by the software system, the section of memory being accessible by the one or more computing systems;
generating a data structure of marketing experience options data representing marketing experience options that are available for delivery to the plurality of present potential customers to encourage the plurality of present potential customers to perform at least one of a number of actions towards becoming paying customers of the tax return preparation system;
storing existing user characteristics data and existing user actions data in the section of memory, the existing user actions data representing the number of actions that were performed by a plurality of prior potential customers who received one or more of the marketing experience options, the existing user characteristics data representing existing user characteristics of the plurality of prior potential customers who performed the number of actions;
training a user experience analytics model to identify preferences of the plurality of present potential customers for the marketing experience options, wherein training the user experience analytics model includes:
defining segments of users that are sub-groups of the plurality of prior potential customers who commonly share one or more existing user characteristics; and
determining levels of performance for the marketing experience options among the segments of users, wherein the levels of performance for the marketing experience options indicate likelihoods of the segments of users to perform one or more of the number of actions in response to receipt of one or more of the marketing experience options;
applying the user characteristics data to the user experience analytics model to associate each of the plurality of present potential customers with at least one of the segments of users, based on similarities between the user characteristics data and the existing user characteristics data;
delivering at least two of the marketing experiences options to at least two subsets of each of the segments of users, to provide at least two different personalized marketing experiences to the plurality of present potential customers of each of the segments of users; and
updating the user experience analytics model, at least partially based on ones of the number of actions performed by the plurality of present potential customers of each of the segments of users in response to receiving the marketing experience options, to identify a more effective one of the at least two different marketing experiences to increase the likelihoods of the segments of users to perform the number of actions.

11. The computer system implemented method of claim 10, wherein the marketing experience options are selected from a group of marketing experience options consisting of:
an email campaign of email messages;
a customer support offer of one or more customer support services;
a price discount off of a price of one or more services provided by a service provider; and
advertisements displayed with a third party computing environment.

12. The computer system implemented method of claim 11, wherein the third party computing environment is a search engine computing environment or a web site provider computing environment.

13. The computer system implemented method of claim 10, wherein the user experience analytics model includes a hierarchical decision tree, the hierarchical decision tree having a plurality of nodes, each node being associated with one of the segments of users and being associated with distribution frequency rates for applying the at least two different personalized marketing experiences to the plurality of present potential customers of each of the segments of users.

14. The computer system implemented method of claim 10, wherein the user characteristics data and the existing user characteristics data are selected from a group of user characteristics data consisting of:
data indicating user computing system characteristics;
data indicating time-related information;
data indicating geographical information;
data indicating external and independent marketing segments;
data identifying an external referrer of the user;
data indicating a number of visits made to a service provider website;
data indicating an age of the user;
data indicating an age of a spouse of the user;
data indicating a zip code;
data indicating a tax return filing status;
data indicating state income;
data indicating a home ownership status;
data indicating a home rental status;
data indicating a retirement status;
data indicating a student status;
data indicating an occupation of the user;
data indicating an occupation of a spouse of the user;
data indicating whether the user is claimed as a dependent;
data indicating whether a spouse of the user is claimed as a dependent;
data indicating whether another taxpayer is capable of claiming the user as a dependent;
data indicating whether a spouse of the user is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user filed a previous years' federal itemized deduction;
data indicating whether the user filed a previous years' state itemized deduction;
data indicating whether the user is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.

15. The computer system implemented method of claim 10, wherein the number of actions are selected from a group of a number actions consisting of:
reading email message content;
selecting a hyperlink from an email message;
visiting a particular web site;
selecting a hyperlink or advertisement from a webpage;
hovering a mouse over a hyperlink or advertisement within a webpage;
providing additional personal information to at least one of the tax return preparation system and the software system;
completing a sequence of questions;
purchasing a service;
filing a tax return with the tax return preparation system; and
using the tax return preparation system for at least a predetermined period of time.

16. The computer system implemented method of claim 10, wherein the tax return preparation system is part of the software system.

17. A non-transitory computer-readable medium, having instructions which, when executed by one or more processors, performs a method for providing personalized marketing experiences to users, comprising:
providing a software system;
receiving, with one or more computing systems that host the software system, user characteristics data for a plurality of present potential customers who are potential customers of a tax return preparation system, the user characteristics data for the plurality of present potential customers representing user characteristics for the plurality of present potential customers;
storing the user characteristics data for the plurality of present potential customers in a section of memory that is allocated for use by the software system, the section of memory being accessible by the one or more computing systems;
generating a data structure of marketing experience options data representing marketing experience options that are available for delivery to the plurality of present potential customers to persuade the plurality of present potential customers to perform at least one of a number of actions towards becoming paying customers of the tax return preparation system;
storing existing user characteristics data and existing user actions data in the section of memory, the existing user actions data representing the number of actions that were performed by a plurality of prior potential customers who received one or more of the marketing experience options, the existing user characteristics data representing existing user characteristics of the plurality of prior potential customers who performed the number of actions;
providing a user experience analytics model implemented using the one or more computing systems;
providing the user characteristics data, the marketing experience options data, the existing user characteristics data, and the existing user actions to the user experience analytics model;
using the user experience analytics model to identify which of the marketing experience options increase a likelihood of causing the plurality of present potential customers to perform at least one of the number of actions,
wherein the user experience analytics model determines which of the marketing experience options increase the likelihood of causing the plurality of present potential customers to perform at least one of the number of actions by determining relationships between the user characteristics data, the existing user characteristics data, and the existing user actions; and
generating personalized marketing experiences for the plurality of present potential customers by populating a first selection of the personalized marketing experiences with a first selection of the marketing experience options based on a likelihood of the first selection of the marketing experience options causing the plurality of present potential customers to perform at least one of the number of actions, and by populating a second selection of the personalized marketing experiences with a second selection of the marketing experience options based on a likelihood of the second selection of the marketing experience options causing the plurality of present potential customers to perform at least one of the number of actions,
wherein populating the first and second selections of the personalized marketing experiences with the first and second selections of the marketing experience options enables the software system to concurrently validate and test effects of the first selection of the marketing experience options and the second selection of the marketing experience options; and
delivering the personalized marketing experiences to the plurality of present potential customers, to increase a likelihood of causing the plurality of present potential customers to complete at least one of the number of actions towards becoming paying customers of the tax return preparation system.

18. The non-transitory computer-readable medium of claim 17, wherein the marketing experience options are selected from a group of marketing experience options consisting of:
an email campaign of email messages;
a customer support offer of one or more customer support services;
a price discount off of a price of one or more services provided by a service provider; and
advertisements displayed with a third party computing environment.

19. The non-transitory computer-readable medium of claim 17, wherein the user characteristics data and the existing user characteristics data are selected from a group of user characteristics data consisting of:
data indicating user computing system characteristics;
data indicating time-related information;
data indicating geographical information;
data indicating external and independent marketing segments;
data identifying an external referrer of the user;
data indicating a number of visits made to a service provider website;
data indicating an age of the user;
data indicating an age of a spouse of the user;
data indicating a zip code;
data indicating a tax return filing status;
data indicating state income;
data indicating a home ownership status;
data indicating a home rental status;
data indicating a retirement status;
data indicating a student status;
data indicating an occupation of the user;
data indicating an occupation of a spouse of the user;
data indicating whether the user is claimed as a dependent;
data indicating whether a spouse of the user is claimed as a dependent;
data indicating whether another taxpayer is capable of claiming the user as a dependent;
data indicating whether a spouse of the user is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user filed a previous years' federal itemized deduction;
data indicating whether the user filed a previous years' state itemized deduction;
data indicating whether the user is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.

20. The non-transitory computer-readable medium of claim 17, wherein the number of actions are selected from a group of number actions consisting of:
reading email message content;
selecting a hyperlink from an email message;
visiting a particular web site;
selecting a hyperlink or advertisement from a webpage;
hovering a mouse over a hyperlink or advertisement within a webpage;
providing additional personal information to at least one of the tax return preparation system and the software system;
completing a sequence of questions;
purchasing a service;
filing a tax return with the tax return preparation system; and
using the tax return preparation system for at least a predetermined period of time.
